(19) United States
(12) Patent Application Publication
(10) Pub. No.: US 2019/0356177 A1
(43) Pub. Date: Nov. 21, 2019

(54) INCREASED WIRELESS POWER TRANSFER FOR WIRELESS POWER TRANSMISSION, AND ASSOCIATED INTERFACE

(71) Applicant: Ossia Inc., Bellevue, WA (US)

(72) Inventor: Philip L. Swan, Redmond, WA (US)

(21) Appl. No.: 15/985,578

(22) Filed: May 21, 2018

(51) Int. Cl. H02J 50/90; H02J 7/02; H02J 50/10; G08B 6/00; G08B 21/18

(52) U.S. Cl. CPC H02J 50/90; H02J 7/025; G08B 21/18; G08B 6/00; H02J 50/10

(57) ABSTRACT

An interface of a device facilitates a user in positioning, orienting or otherwise moving a wireless power receiver of the device (and/or the wireless power transmitter) to increase an amount, strength, efficiency, consistency, etc. with which power is received by the wireless power receiver from the wireless power transmitter. For instance, a device comprising a processor can obtain information indicating a motion applicable to the device to increase an amount of wireless power that a wireless power receiver is receiving from a power transmitter. A user interface of the device can then render the information such that when the device is moved according to the motion, the amount of wireless power that is being received by the device is thereby increased.

### TECHNICAL FIELD

The subject disclosure generally relates to movement, positioning, and/or orientation of a wireless power receiver and/or a wireless power transmitter resulting in increases in amount of wireless power transfer, e.g., efficiency, strength, rate, consistency, etc. of wireless power transfer, between the wireless power transmitter and the wireless power receiver, and further to an associated interface that facilitates the movement, positioning, and/or orientation of the wireless power receiver and/or the wireless power transmitter.

### BACKGROUND

Conventional wireless power transmission systems can wirelessly deliver power to devices via inductive charging, or line of sight beamforming. In this regard, wireless power transmission and reception systems are proliferating and becoming commercially feasible in the marketplace. However, some aspects of them remain difficult from a consumer standpoint, such as how best to extract power for a given device to be charged across a variety of different scenarios, e.g., a consumer may not realize that other real objects, other than the transmitter and receiver, are having a negative impact on the way the receiver is receiving power from the transmitter.

The above-described background relating to wireless power transfer between transmitter and receiver is merely intended to provide a contextual overview of some current issues, and is not intended to be exhaustive. Other contextual information may become further apparent upon review of the following detailed description.

### BRIEF DESCRIPTION OF DRAWINGS

FIG. 1 illustrates a block diagram of a power transmitter apparatus and a wireless power receiver device, in which a user interface of the wireless power receiver device guides a movement and/or orientation of the wireless power receiver device based on movement information and/or orientation information obtained by the wireless power receiver device, in accordance with various example embodiments.

FIG. 2 illustrates a block diagram of a power transmitter apparatus and a wireless power receiver device, in which a user interface, separate from the wireless power receiver device, guides a movement and/or orientation of the wireless power receiver device based on movement information and/or orientation information obtained by the wireless power receiver device, in accordance with various example embodiments;

FIG. 3 is an illustration of an example user interface that can render motion information and/or orientation information via user interface component(s) to facilitate movement and/or reorientation of the device to improve power reception by the wireless power receiver, in accordance with aspects of the subject disclosure;

FIG. 4 is an illustration of an example user interface that can that can render directional information to facilitate movement and/or reorientation of the device to improve power reception by the wireless power receiver, in accordance with aspects of the subject disclosure;

FIG. 5 is an illustration of an example user interface that can that can render motion information and/or orientation information via user interface component(s) to facilitate movement and/or reorientation of the device to improve power reception by the wireless power receiver, wherein the motion information and/or orientation information takes into account objects that interfere with or block wireless power transmissions, or objects that may be sensitive to wireless power transmissions such as flesh objects, in accordance with aspects of the subject disclosure;

FIG. 6 is an illustration of an example method for a wireless power receiver where movement information and/or orientation information indicating a movement and/or reorientation for the wireless power receiver to undergo is obtained and rendered to improve an amount of power reception by the wireless power receiver, in accordance with aspects of the subject disclosure;

FIG. 7 illustrates an example computer readable medium comprising executable instructions that, when executed, facilitate a wireless power receiver to obtain and render movement information and/or orientation information indicating a movement or reorientation for the wireless power receiver to undergo to improve an efficiency of power reception by the wireless power receiver, in accordance with aspects of the subject disclosure;

FIG. 8 illustrates an example device that obtains and renders movement information and/or orientation information indicating a movement and/or reorientation for a wireless power receiver device to undergo to improve an amount of power reception by the wireless power receiver device, in accordance with aspects of the subject disclosure;

FIG. 9 illustrates an example wireless power transmission apparatus that facilitates a determination of movement information and/or orientation information on behalf of the wireless power receiver that can be sent to the wireless power receiver to facilitate movement and/or reorientation of the wireless power receiver to improve power reception by the wireless power receiver, in accordance with aspects of the subject disclosure;

FIG. 10 depicts a block diagram of an example wireless power delivery environment illustrating wireless power delivery from one or more wireless power transmission systems to various wireless devices within the wireless power delivery environment, in accordance with various example embodiments;

FIG. 11 depicts a sequence diagram illustrating example operations between a wireless power transmission system and a wireless receiver client for commencing wireless power delivery, in accordance with various example embodiments;

FIG. 12 depicts a block diagram illustrating example components of a wireless power transmission system, in accordance with various example embodiments;

FIG. 13 depicts a block diagram illustrating example components of a wireless power receiver client, in accordance with various example embodiments;

FIGS. 14A and 14B depict block diagrams illustrating example multipath wireless power delivery environments, in accordance with various example embodiments;

FIG. 15 depicts a block diagram illustrating example components of a representative mobile device or tablet computer with a wireless power receiver or client in the form of a mobile (or smart) phone or tablet computer device, in accordance with various example embodiments; and

FIG. 16 depicts a diagrammatic representation of a machine, in an example form, of a computer system within which a set of instructions, for causing the machine to perform any one or more of the methodologies discussed herein, may be executed, in accordance with various example embodiments.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

As mentioned, there are various types of wireless power transmission, and such wireless power transmission allows a receiving device to receive power that is wirelessly directed to the receiving device. In this regard, wireless power transmission can cause higher or lower energy densities in different regions of the room depending on surrounding objects and their characteristics, and a receiving device, depending on in what region it is located, can receive more or less power from a higher or lower energy density, respectively, e.g., a video game controller can charge wirelessly when placed in a region of higher energy density caused by transmission of electromagnetic energy to the region, but when moved to a region of lower energy density, will experience a reduction in the amount of wireless charge it is receiving from the transmitter owing to the lower energy density. In this regard, the receiver (or transmitter) can be proximate to an object that can affect such energy densities, and/or the object itself can be affected by higher energy density areas.

Some wireless power transmission systems maintain flexible positioning or movement of a device comprising the wireless power receiver, such as wireless power transmission systems described herein below. Where such flexibility exists as to where to position a wireless power receiver, a consumer may be left in the dark about movements or orientations that could vastly improve the quality or quantity of power being received by the wireless power receiver, or about objects in the environment that are interfering with or blocking reception of power. In this regard, conventional wireless power transmission technologies have had some drawbacks with respect to knowing where to position or move and how to orient a power receiving device to achieve the best, or at least a better, possible amount (e.g., strength, rate, efficiency, consistency, etc.) of wireless power transfer from a wireless power transmission apparatus. As mentioned, the amount of wireless power transfer is dependent on characteristics, such as the position and orientation of the wireless power receiver within, affixed to, or couple to, a power receiving device. Wireless power is invisible to the user, so there is currently no easy way for a user to move, reposition and/or reorient a power receiving device to achieve the best, or at least a better, possible amount of wireless power transfer.

Even wireless power transmission technologies that are not flexible with respect to positioning of the transmitter and/or receiver may benefit some from embodiments described herein. For example, beamforming solutions that require line of sight have little flexibility as to where to position the wireless power receiver since line of sight is to be maintained with such technologies, however, even with such solutions, it might be beneficial for a consumer to know if moving the device might improve the line of sight from the power transmitter to the wireless power receiver (e.g., maybe the wireless power receiver is mis-aligned slightly according to the naked eye, or an interfering object can be moved). Similarly, inductive wireless charging solutions have little flexibility where to position the wireless receiver since the device with the wireless receiver is placed in touch or at least close contact with the power transmitter (e.g., power transmitter pad), however, even with such solutions, it might be beneficial for a consumer to know if moving the device relative to the power transmitter might improve wireless power transfer, e.g., conventionally, a user can only know whether a device is charging, or not charging, according to such technologies, with no information about the efficacy of power transfer, or whether it can be improved, let alone how to do it.

Consequently, conventional wireless power transmission technologies have had some drawbacks, some of which may be noted with reference to the various embodiments described herein below. Various embodiments disclosed herein can effectively inform where to move, position and/or how to orient a power receiving device to achieve an increased amount of wireless power transfer, such as increased strength, rate, efficiency, consistency, etc. of wireless power transfer, from a wireless power transmission apparatus.

To the accomplishment of the foregoing and related ends, the disclosed subject matter, then, comprises one or more of the features hereinafter more fully described. The following description and the annexed drawings set forth in detail certain illustrative aspects of the subject matter. However, these aspects are indicative of but a few of the various ways in which the principles of the subject matter can be employed. Other aspects, advantages, and novel features of the disclosed subject matter will become apparent from the following detailed description when considered in conjunction with the provided drawings.

Addressing the above and other issues associated with wireless power transmission technologies, various embodiments disclosed herein can, by making recommendations via a user interface, e.g., display, speaker, vibration component, etc. regarding how to move or reorient a wireless receiver device (and/or a wireless transmitter device) to increase an amount, e.g., strength, rate, efficiency, consistency, etc., of wireless transfer of power from one or more power transmitter apparatuses to one or more wireless power receivers of the wireless receiver device.

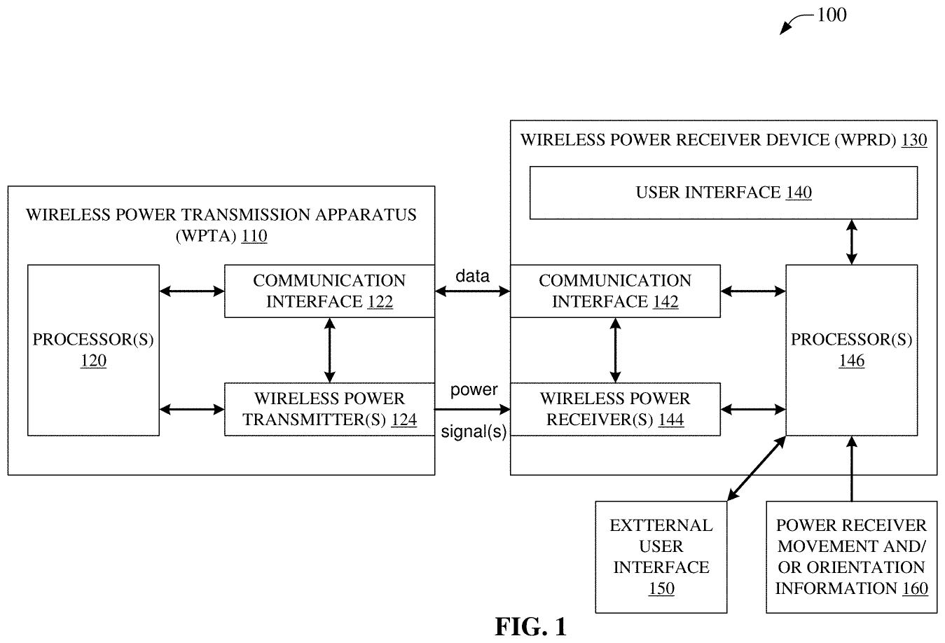

In this regard, and now referring to FIG. 1, a non-limiting, example block diagram 100 is shown of a wireless power transmission apparatus 110 that wirelessly transfers power to a wireless power receiver device 130. The wireless power transmission apparatus 110 can comprise processor(s) 120, a communication interface 122, and wireless power transmitter(s) 124. The processor(s) 120 and the wireless power transmitter(s) 124 are communicatively coupled to facilitate the transmission of power signal(s) (e.g., wireless transfer of power) from the wireless power transmitter apparatus 110, via the wireless power transmitter(s) 124, to the wireless power receiver(s) 144 coupled to the wireless power receiver device 130. The processor(s) 120 and the communication interface 122 are communicatively coupled to facilitate the transmission of data from the communication interface 122 to the communication interface 142. In some embodiments, the wireless power transmitter(s) 124 and the communication interface 122 are both implemented using a same antenna or antennae array, though alternatively, they can be implemented as separate components.

For example, in a non-limiting embodiment, the wireless power transmission apparatus 110 can determine movement and/or orientation information 150 related to how wireless power receiver device 130 can be moved and/or re-oriented to increase power transfer, and the movement and/or orientation information 160 can be sent to the wireless power receiver device 130 via the communication interface 122. In other embodiments, the wireless power receiver device 130 determines the movement and/or orientation information 160 based on past measurements of power consumption by the wireless power receiver device 130. Alternatively, the wireless power receiver device 130 can obtain the movement and/or orientation information 160 from an external device, such as a network device, or mobile device communicatively coupled to the wireless power receiver device 130.

The wireless power receiver device 130 comprises processor(s) 146, a communication interface 142 that can send or receive data to or from communication interface 122, power receiver(s) 144 that receive power signals from power transmitter(s), and a user interface 140 that is configured to display the movement and/or orientation information 160 to urge moving of the device to a better position or orientation.

Where the wireless power receiver device 130 does not itself comprise the user interface 140, or where user interface 140 only comprises partial rendering capability (e.g., beeping sound only), an external user interface 150 (e.g., UI of a mobile phone app) can be communicatively coupled, e.g., paired, to the wireless power receiver device 130 to replace or supplement user interface 140. In this regard, if the wireless power receiver device 130 does not comprise a user interface 140, the external user interface 150 can instead be used to facilitate guiding the wireless power receiver device 130 to a new position or orientation. If the user interface 140 of the wireless power receiver device 130 is limited, e.g., if it has LEDs only, the LEDs may not be suitable to facilitate a user moving the device properly, and thus in such an example, a user can benefit from the contribution of external user interface 150 in guiding the wireless power receiver device 130 to a new position or orientation.

In at least one embodiment, an external user interface 150 can be provided as part of a second device (such as a smart phone or tablet) coupled to the wireless power receiver device 130. In various alternatives, the wireless communication device 130 is stationary and does not have a user interface (such as an IoT-enabled smoke detector) and the user interface 140 is affixed on or within a second device (e.g., mobile device) which is physically connected (e.g., via USB or Ethernet cable) or wireless connected (e.g., via Wi-Fi or Bluetooth) to the wireless power receiver device 130.

In other embodiments, the wireless communication device 130 is intended to be stationary at rest, and does not have a user interface (such as a wirelessly chargeable “AA” battery) or does not have a sophisticated user interface (such as a smoke detector or an electronic shelf tag), and thus, the external user interface 150 of a second device (such as a smart phone or tablet) can be wirelessly connected to the wireless power receiver device 130, to facilitate the movement of the wireless power receiver device 130 to improve wireless power transfer.

The processor(s) 146, the wireless power receiver(s) 144, and the communication interface 142 are communicatively coupled to facilitate the reception of data, such as movement and/or orientation information 160, from the communication interface 122 regarding, or transmission of data, such as power consumption information, to the communication interface 122 regarding the amount of wireless power being received by the wireless power receiver(s) 144. Data transmitted from the communication interface 142 to the communication interface 122 can further comprise location information regarding the current location of the wireless power receiver device 130. The processor(s) 146, and the user interface 140 are communicatively coupled to facilitate the rendering of the movement and/or orientation information 160, in accordance with various example embodiments, which guide a user with respect to how a receiver device can be moved to increase power transfer characteristic(s) associated with charging the receiver device.

In various alternatives, the communication interface 122 can be an antenna or antennae, e.g., arranged in an array, comprised of a highly conductive material, metal deposit, indium tin oxide (ITO), thick ITO, gold, silver, copper, aluminum, and/or titanium, and the wireless power transmission apparatus 110 can comprise, but not be limited to comprising, a flat panel substrate and/or a curved panel substrate constructed of glass, metal, plastic, ceramic, or any other useful material.

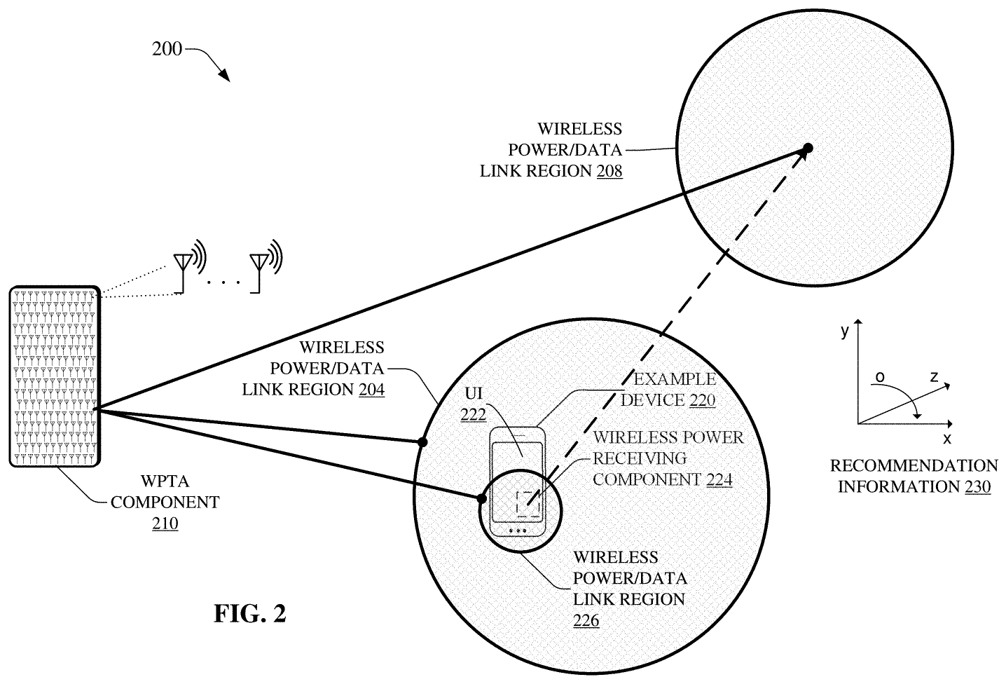

Now referring to FIG. 2, a block diagram 200 of an example wireless power transmission apparatus 210 that wirelessly transfers power to a power receiving component 224 of example device 220 comprising a user interface 222 that renders at least the movement and/or orientation information 160, in accordance with various example embodiments, so that the power receiving component 224 of example device 220 might be moved to a position where characteristic(s) of receiving power from wireless power transmission apparatus 210 are improved.

In this regard, in one illustration, example device 220 is located within a wireless power/data link region 204, however, via user interface 222, recommendation information 230 has been rendered that has helped the user of example device 220 to find a more targeted wireless power/data link region 226 for receiving power within the wireless power/data link region 204 for improved power reception. Alternatively, recommendation information 230, representing the movement and/or orientation information 160, can be displayed via user interface 222 that guides the movement of the example device 220 to a new wireless power/data link region 208 where power transfer to power receiving component is an improvement over all of wireless power/data link region 204 including wireless power/data link region 226.

In at least one embodiment, data comprising movement and/or orientation information recommended in recommendation information 230 comprises a direction on a 2-D plane (e.g., x-y axis) the wireless power receiver device 220 should be moved to increase the amount of wireless power being received by the wireless power receiver component(s) 224, e.g., to where in a room (e.g., in the plane of the floor) should a user move the device 220 in order to achieve better power.

In other variations, the data comprising movement and/or orientation information recommended in recommendation information 230 comprises a direction on a 2-D plane (e.g., x-y axis), and a distance along that 2-D direction that the wireless power receiver device 130 should be moved to increase the amount of wireless power being received by the wireless power receiver(s) 144, e.g., vector information, such as an arrow, that comprises both directional information and scalar information. In one embodiment, as the device 220 moves, the vector information is updated, e.g., if the device 220 is closer to a recommended spot for receiving power, the scalar information (e.g., the distance) becomes smaller, or vice versa. In yet another embodiment, temporal information is displayed about an estimated time to full charge based on a current charging rate at the current location/orientation.

As yet another alternative, the data comprising movement and/or orientation information 160 received by the communication interface 142 and recommended in recommendation information 230, processed by the processor(s) 146, and rendered by the user interface 140 comprises a direction in 3-D space (e.g., x-y-z axis) the wireless power receiver device 130 should be moved to increase the amount of wireless power being received by the wireless power receiver(s) 144. For example, it might be that a metal object, such as a book shelf or pipe, is interfering with power signals being received by a device, in which case moving the device vertically over the book shelf, in addition to or instead of, movement in the 2-D plane of the floor, can improve power reception characteristics and can be taken into account when making recommendations to improve power via a user interface, such as user interfaces 140 and/or 150.

In various embodiments, the data comprising movement and/or orientation information 160 received by the communication interface 142, processed by the processor(s) 146, and rendered by the user interface 140 comprises a direction on a 3-D plane (e.g., x-y-z axis). Optionally, such embodiment can also include a distance along that 3-D direction the wireless power receiver device 130 should be moved to increase the amount of wireless power being received by the wireless power receiver(s) 144.

In some embodiments, the data comprising movement and/or orientation information 160 received by the communication interface 142, processed by the processor(s) 146, and rendered by the user interface 140 comprises an orientation change or an angle change on a 2-D or 3-D plane (e.g., ‘o’ as shown in the x-y-z axis of recommendation information 230) that the wireless power receiver device 130 should undergo to increase the amount of wireless power being received by the wireless power receiver(s) 144. For example, it may be that if a plane associated with the wireless power receiver device 130, or a plane associated with the wireless power receiver(s) 144 of the wireless power receiver device 130, is re-oriented by, for example, re-angling the plane to be more orthogonal to a power reception direction associated with receiving power signals from the wireless power transmission apparatus 110. This could involve any of changing a yaw, pitch and/or roll of the wireless power receiver device 130.

In at least one embodiment, the wireless power receiver device 130 is not ultimately intended to be stationary (such as a mobile device) and the data transmitted from the communication interface 142 to the communication interface 122 further comprises first information regarding the initial location of the wireless power receiver device 130, and, after the wireless power receiver device 130 has moved to a new location, second information regarding the new location of the wireless power receiver device 130 can also become part of the determination of movement and/or orientation information 160. In this regard, over time, the system can learn regions of an environment that are suitable for receiving power from a given wireless power transmission apparatus 110, and substitute a location-based lookup for the wireless power receiver device 130 as an expedient proxy for directing the wireless power receiver device 130 to improved power reception based on actual, or real-time, measurements.

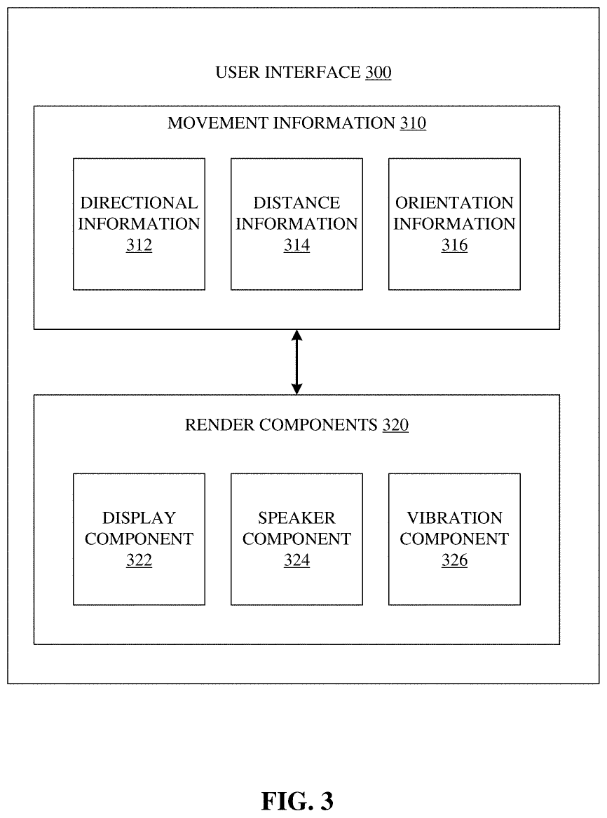

Now referring to FIG. 3, a block diagram of an example, non-limiting, user interface 300 is shown, which renders movement information 310 comprising directional information 312, distance information 314, and/or orientation information 316 via render components 320 comprised of a display component 322, a speaker component 324, and/or a vibration component 326, in accordance with various example embodiments.

In various embodiments, the directional information 312, distance information 314, and/or orientation information 316 comprise information about at least one motion that has been determined to have satisfied a condition that avoids at least one interference-causing obstacle positioned between a wireless power receiver device and a wireless power transmission apparatus. The term “motion” as used herein is intended to be all encompassing in that it covers not only movement of the device in one or more of X, Y, or Z axes, but also covers any reorientation where the position of the device may stay the same, but an angle has changed, e.g., the device undergoing a change in a yaw, pitch and/or roll is considered a motion applicable to the device herein.

Alternatively, the directional information 312, distance information 314, and/or orientation information 316 comprise information about at least one motion that has been determined to have satisfied a condition that avoids at least one interference-causing obstacle comprised of flesh positioned between a wireless power receiver device and a wireless power transmission apparatus.

In other embodiment, the directional information 312, distance information 314, and/or orientation information 316 comprise at least one motion that has been determined to have satisfied a condition that avoids at least one interference-causing obstacle in proximity of a wireless power receiver device.

In at least one embodiment, the directional information 312, distance information 314, and/or orientation information 316 comprise at least one motion that has been determined to have satisfied a condition that avoids at least one interference-causing obstacle comprised of flesh in proximity of a wireless power receiver device.

In various alternatives, the display component 322 is a screen on a device and the movement information 310 is displayed as an arrow pointing in the desired direction of movement of a wireless power receiver device which will increase the wireless transfer of power, the arrow shrinking or growing in size depending on whether the wireless power receiver device is closer (shorter/smaller arrow) or farther (longer/larger arrow) from the point in space and/or angle of orientation where wireless transfer of power will be increased.

In other embodiments, the display component 322 is a screen on a device and the movement information 310 comprised of directional information 312 and/or distance information 314 is displayed as a set of bars of increasing height that depict the movements information 310 by illuminating none of the bars when a wireless power receiver device is not close to the point in space where wireless transfer of power will be increased, and illuminating all of the bars when the wireless power receiver device is close to the point in space where wireless transfer of power will be increased. The number of bars illuminated increases as the wireless power receiver device is moved closer to the point in space where wireless transfer of power will be increased, and decreases as the wireless power receiver device is moved farther away from the point in space where wireless transfer of power will be increased.

In some embodiments, the display component 322 is a screen on a device and the movement information 310 comprised of orientation information 316 is displayed as a 360 degree compass with a dial wherein the dial indicates an angle a wireless power receiver device should be oriented to increase the wireless transfer of power.

In at least one alternative, the display component 322 is a screen on a device and the movement information 310 is displayed alpha numerically as words or text on the screen indicating the direction and/or distance and/or angle a wireless power receiver device should be moved and/or oriented to increase the wireless transfer of power. As another option, the estimated amount of time until the device will be fully charged can be estimated and displayed so that the user can determine the device is positioned and/or oriented well enough for a given situation (e.g., the user can determine if the device is positioned and/or oriented well enough to become fully charged after going to lunch). Similarly, an estimated time that the device will reach full charge can also be displayed based on the current rate of wireless transfer of power. Alternatively, or in addition, time information can be displayed regarding an estimated change in total time to a fully charged state if the user moves and/or reorients the device according to a recommendation. Similarly, For instance, instead of or in addition to the estimated time to full charge at a first location/orientation, the device can render information about how much time will be saved in reaching the full charge is the user moves/reorients the device to the second location/orientation.

In various embodiments, the speaker component 324 is a speaker on a wireless power receiver device and the movement information 310 is depicted as audio feedback comprising beeps wherein the beeps are more frequent and/or louder as a wireless power receiver device is moved closer to a point in space and/or an angle where the wireless transfer of power will be increased, and the beeps are less frequent and/or less loud as the wireless power receiver device is moved farther away from the point in space where the wireless transfer of power will be increased.

In some embodiments, the speaker component 324 is a speaker on a wireless power receiver device and the movement information 310 is depicted as audio feedback comprising a synthesized voice in a language selected by a used that indicates the direction and/or distance and/or angle a wireless power receiver device should be moved and/or oriented to increase the wireless transfer of power.

Alternatively, the vibration component 326 is a vibrating electric motor on a wireless power receiver device and the movement information 310 is depicted as haptic feedback comprising increased vibration intensity as a wireless power receiver device is moved closer to a point in space and/or an angle where the wireless transfer of power will be increased, and decreased vibration intensity as the wireless power receiver device is moved farther away from the point in space and/or angle where the wireless transfer of power will be increased.

In other embodiments, the vibration component 326 is a vibrating electric motor on a wireless power receiver device and the movement information 310 is depicted as haptic feedback comprising vibration(s) localized on a specific portion of the surface of the wireless power receiving device wherein the location of the vibration(s) indicates the direction the wireless power receiver device should be moved and/or the angle the wireless power receiver device should be oriented to increase the wireless transfer of power.

In another embodiment, a wireless power receiving device can enable or disable the feature of rendering the information about how the wireless power receiver device should be moved and/or the angle according to which the wireless power receiver device should be oriented to increase the wireless transfer of power. For instance, an input can be received by the wireless power receiver device that at least one of enables the rendering of the information where the rendering is disabled, or disables the rendering of the information where the rendering is enabled.

There are a variety of ways to enable and disable the feature. Enabling could include: a) a user input to the UI (screen or buttons), b) coming into the range of at least one Power Transmitter, or c) having the device's state of charge cross a threshold. Disabling could include: a) a user input to the UI (screen or buttons), b) going out of range of at least one Power Transmitter, c) having the device's state of charge cross a threshold, or d) having the device detect that it is no longer actively being handled by the user (could still be in motion though, e.g., put down the device in the cup holder of a car).

The enabling the rendering of the information can thus be in response to any one or more of receiving an input via the interface of the device, determining that the device is within a defined range of the at least one power transmitter, determining that a current amount of charge of the device has decreased below a threshold amount of charge defined for the device, or other defined circumstance where enabling the rendering may be beneficial to the user in charging the device.

The disabling the rendering of the information can thus be in response to any one or more of receiving an input via the interface of the device, determining that the device is outside of a defined range of the at least power transmitter, determining that a current amount of charge of the device has increased above a threshold amount of charge defined for the device, determining that the device is in a state of inactivity by a user of the device, or other defined circumstance where disabling the rendering may be beneficial to the user.

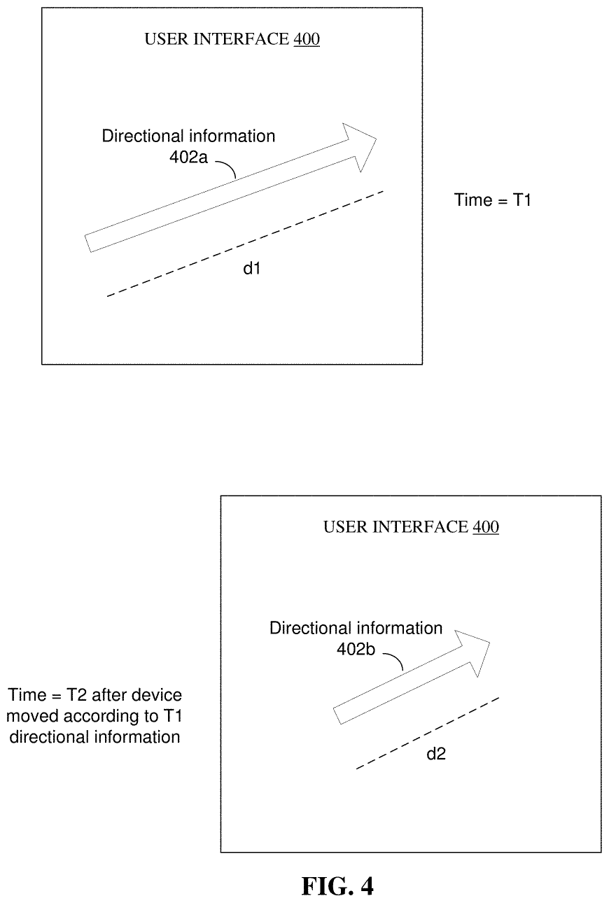

Now referring to FIG. 4, a block diagram of a user interface 400 rendering first directional information 402a which is rendered before a wireless power receiver device associated with the user interface 400 has been moved T1 and comprising at least one motion applicable to a wireless power receiver device that will increase the amount of wireless power received by the wireless power receiver device, and second directional information 402b which is rendered after the wireless power receiver device has been moved T2 in accordance with the first directional information 402a comprising at least one motion applicable to a wireless power receiver device that will increase the amount of wireless power received by the wireless power receiver device, in accordance with various example embodiments.

In some embodiments, the first directional information 402a and the second directional information 402b are rendered by the user interface 400 as an arrow pointing in the desired direction of movement of a wireless power receiver device which will increase the wireless transfer of power, the arrow shrinking in size from d1 to d2 from time=T1 to time=T2 in FIG. 4 or growing in size depending on whether the wireless power receiver device is closer (shorter/smaller arrow) or farther (longer/larger arrow) from the point in space where wireless transfer of power will be increased.

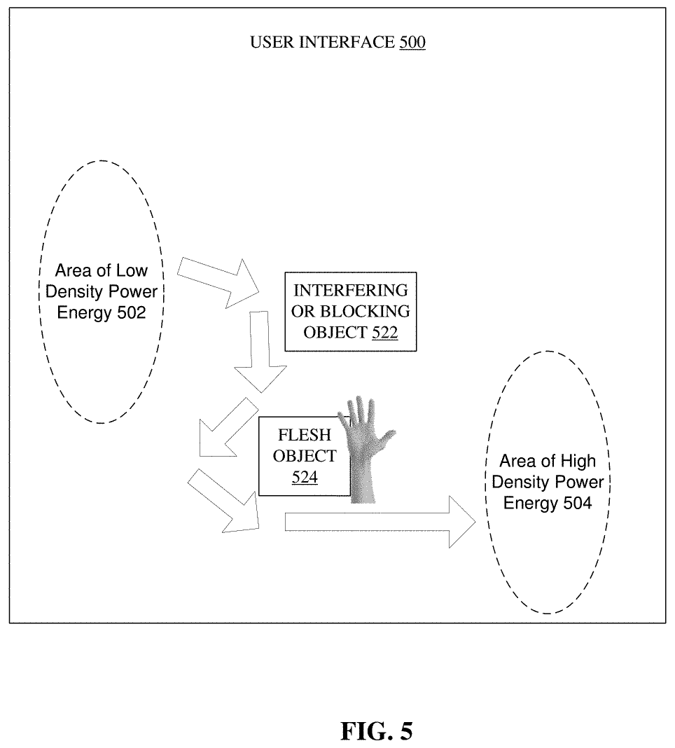

Now referring to FIG. 5, a block diagram of a user interface 500 rendering first information regarding the presence of one or more interference or blocking object(s) 522 and/or one or more flesh object(s) 524 in between a wireless power transmission apparatus and a wireless power receiver device and/or in the proximity of the wireless power receiver device causing an area of low density power energy 502, and second information regarding a location (or locations) where there is an area (or areas) of high density power energy 504, in accordance with various example embodiments.

In at least one alternative, the area of low density power energy 502 is caused by a blocking object 522 (e.g., a wall in between the wireless power transmission apparatus and the wireless power receiver device) and the area(s) of high density power energy 504 is(are) on the other side of the blocking object 522 (e.g., a wall in between the wireless power transmission apparatus and the wireless power receiver device) and/or on the side(s) of the blocking object 522 (e.g., on the other side of the wall and/or in the doorway or other opening(s) in the wall).

Alternatively, the area of low density power energy 502 is caused by a flesh object 524 (e.g., a person's hand holding the wireless power receiver device) and the area(s) of high density power energy 504 is(are) on the side(s) of the flesh object 524 and/or in front of the flesh object 524 (e.g., an area of high density power energy can be reached by either moving the wireless power receiver device to either side of the person's hand or by moving the person's hand or individual fingers to end the blockage).

In various alternatives, the area of low density power energy 502 is caused by an interference-causing object 502 (e.g., a Wi-Fi device such as an Internet router) in proximity of a wireless power receiver device, and the area(s) of high density power energy 504 is(are) outside the range of the interference-causing object's 502 range (e.g., an area of high density power energy 504 can be reached by either removing the Wi-Fi device from the proximity of the wireless power receiver device or by moving the wireless power receiver device outside of the Wi-Fi device's range).

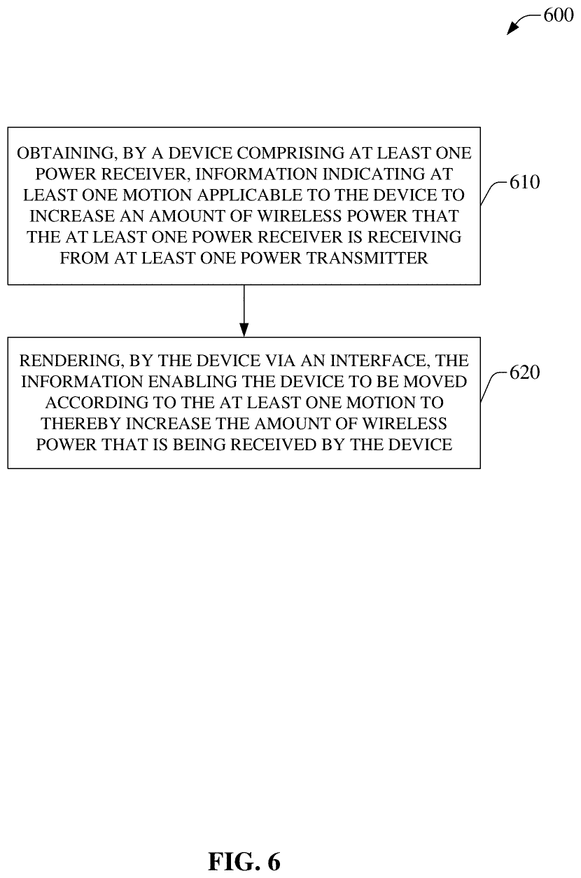

In view of the example system(s) described above, example method(s) that can be implemented in accordance with the disclosed subject matter can be better appreciated with reference to flowcharts in FIG. 6-FIG. 9. For purposes of simplicity of explanation, example methods disclosed herein are presented and described as a series of acts; however, it is to be understood and appreciated that the claimed subject matter is not limited by the order of acts, as some acts may occur in different orders and/or concurrently with other acts from that shown and described herein. For example, one or more example methods disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a described example method in accordance with the subject specification. Further yet, two or more of the disclosed example methods can be implemented in combination with each other, to accomplish one or more aspects herein described. It should be further appreciated that the example methods disclosed throughout the subject specification are capable of being stored on an article of manufacture (e.g., a computer-readable medium) to allow transporting and transferring such methods to computers for execution, and thus implementation, by a processor or for storage in a memory.

FIG. 6 is an illustration of an example method for a wireless power receiver where movement information, indicating a movement or reorientation for the wireless power receiver to undergo, is obtained and rendered to improve an amount of power reception by the wireless power receiver, in accordance with aspects of the subject disclosure. At 610, method 600 can comprise obtaining, by a device comprising at least one power receiver, information indicating at least one motion applicable to the device to increase the amount of wireless power that the at least one power receiver is receiving from at least one power transmitter. For the avoidance of doubt, the at least one motion can be any motion including a re-positioning and/or a re-orienting of the at least one power receiver, e.g., any change in location or angle of at least part of the device. In addition, it is noted that any embodiment described herein with reference to one wireless power receiver can apply to one or more wireless power receivers, and similarly, any embodiment described herein with reference to one wireless power transmitter can apply to one or more wireless power transmitters.

In some embodiments, the obtaining the information can comprise obtaining the information from the power transmitter apparatus. In other embodiments, the obtaining the information can comprise determining the information by the device. In addition, the obtaining the information can comprise obtaining the information from another device, e.g., a different device other than the power transmitter apparatus and the device, that is connected to the power transmitter apparatus and connected to the device.

At 620, method 600 can further comprise rendering, via an interface, the information enabling the device to be moved according to the at least one motion to thereby increase the amount of wireless power that is being received by the device.

In this regard, the rendering of the information can comprise rendering directional information via the interface about a direction toward which the device is to be moved or reoriented to increase the amount of wireless power that is being received. The rendering of the directional information can comprise rendering an arrow indicating the direction toward which the device is to be moved or reoriented to increase the amount of wireless power that is being received. The rendering of the directional information can also comprise rendering distance information representative of a distance along the direction that the device is to be moved from a current location to increase the amount of wireless power that is being received. Alternatively, the rendering of the directional information can comprise rendering at least one of text, or the text rendered as speech, indicating the direction toward which the device is to be moved or reoriented to increase the amount of wireless power that is being received.

In another embodiment, the rendering of the directional information can comprise rendering vibratory feedback indicating the direction toward which the device is to be moved or reoriented to increase the amount of wireless power that is being received.

As another alternative, the rendering of the information can comprise rendering rate information about at least one of a change in position of the device or a change in orientation of the device to increase a rate of power transfer to the at least one power receiver.

Optionally, the rendering of the information can comprise displaying the information, and updated information can be repeatedly displayed as the information changes as a result of moving the device according to the at least one motion.

As yet another option, the rendering of the information can comprise initiating haptic feedback associated with the information, and the haptic feedback can be repeatedly varied resulting in updated haptic feedback, wherein the updated haptic feedback is updated in proportion to the amount of power being received by the device as the information changes as a result of moving the device according to the at least one motion. The repeatedly varying of the haptic feedback can comprise repeatedly varying at least one of a strength of the haptic feedback at a specified position on the device, or at a position on the device where the haptic feedback is to be felt, according to the at least one motion. In this regard,

It is noted that in practice, haptics might not be implemented to increase/decrease proportionally, and that it can be any function. Thus, in an alternate embodiment, the haptic feedback can vary in at least one manner when the device's change in orientation or position is causing power reception to improve and in at least one other manner when the device's change in orientation or position is not causing power reception to improve. For instance, in response to the amount of power being received by the device increasing as a result of moving the device, the updated haptic feedback can be updated according to a first function, and in response to the amount of power being received by the device decreasing as a result of moving the device, the updated haptic feedback can be updated according to a second function different than the first function. The first function can be designed to use haptic feedback to encourage the moving of the device to increase wireless power transfer, and the second function can be designed to use haptic feedback to discourage the moving of the device in a way that will decrease wireless power transfer.

Also, it is noted that haptic feedback can also communicate direction and orientation. As an example, oscillations can be designed to make a user feel like the device wants to move or twist in a certain direction. In this regard, oscillations can be designed to inhibit a motion that leads to less power, e.g., any one or more of an intensity, a point of origin, or a force associated with the oscillations can be controlled to oppose a user motion (change of position and/or orientation) when the user motion does, or is going to, result in a decrease in amount of wireless power being transferred. In addition, or alternatively, any one or more of the intensity, the point of origin, or the force associated with the oscillations can be controlled to facilitate a user motion when the user motion does, or is going to, result in an increase in amount of wireless power being transferred.

Also, the rendering of the information can comprise rendering information regarding the presence of an interference-causing obstacle between the device and the power transmitter, enabling the device to thereby increase the amount of wireless power that is being received by at least one of moving the interference-causing obstacle or moving the device to reduce an effect of interference by the interference-causing obstacle on transmissions by the power transmitter as a result of increasing a degree to which the interference-causing obstacle is avoided by the transmissions.

Similarly, the rendering of the information can comprise rendering information regarding the presence of living tissue between the device and the power transmitter, enabling the device to thereby increase the amount of wireless power that is being received by at least one of moving the device or moving the living tissue to facilitate a decrease in transmissions by the power transmitter that are redirected or not transmitted in order to avoid the transmissions passing through the living tissue.

In addition to visual or vibratory feedback about to where to move the power receiving device, the rendering of the information can comprise initiating audio feedback associated with the information, and the audio feedback can be repeatedly varied resulting in updated audio feedback, wherein the updated audio feedback is updated in proportion to the amount of power being received by the device as the information changes as a result of moving the device according to the at least one motion. The repeatedly varying the audio feedback can comprise repeatedly varying at least one of a strength of the audio feedback, a frequency of the audio feedback, or a frequency of occurrence of the audio feedback.

In one embodiment, method 600 optionally comprises transmitting, to the power transmitter, a signal comprising information regarding the amount of wireless power that the at least one power receiver is receiving from the power transmitter.

In yet another embodiment, the device is in motion, and method 600 can further comprise transmitting, by the device to at least one other device, a signal comprising location change information indicating that a location of the device has changed from where the device was located when the device obtained the first information. In response, method 600 can further comprise, receiving, by the device, new location information representative of a new location of the device to where to move the device to increase the amount of wireless power that is being received by the device. Further, method 600 can comprise, rendering, by the device, the new location information representative of the new location of the device.

In another embodiment where the device is in motion, trajectory information about a trajectory of the device in motion can be determined based on a current location of the device and prior locations of the device previous to the current location. In this regard, method 600 can further comprise use of the trajectory information to determine, relative to the trajectory of motion of the device, new location information representative of a new location of the device to which to move the device along the trajectory of motion of the device to increase the amount of wireless power that the at least one power receiver is receiving. In addition, the new location information representative of the new location of the device can be rendered.

Regarding the amount of wireless power, the amount of wireless power that the at least one power receiver is receiving can be determined as a statistical function of an aggregate amount of power received over a defined period of time by the at least one power receiver. The statistical function of the aggregate amount of power received over the defined period of time by the at least one power receiver can be an average amount of the aggregate amount of power. The amount of wireless power that the at least one power receiver is receiving can be determined from a most recent measure of a currently being received amount of power by the at least one power receiver.

In other variations, the at least one motion applicable to the device that satisfies the at least one condition can comprise: 1) a motion that satisfies a condition that avoids at least one interference-causing obstacle positioned between the device and the power transmitter apparatus, 2) a motion that satisfies a condition that avoids at least one object that has been determined to comprise flesh and that is positioned between the device and the power transmitter apparatus, or 3) a motion that results in removal of at least one obstacle determined to be in proximity of the device.

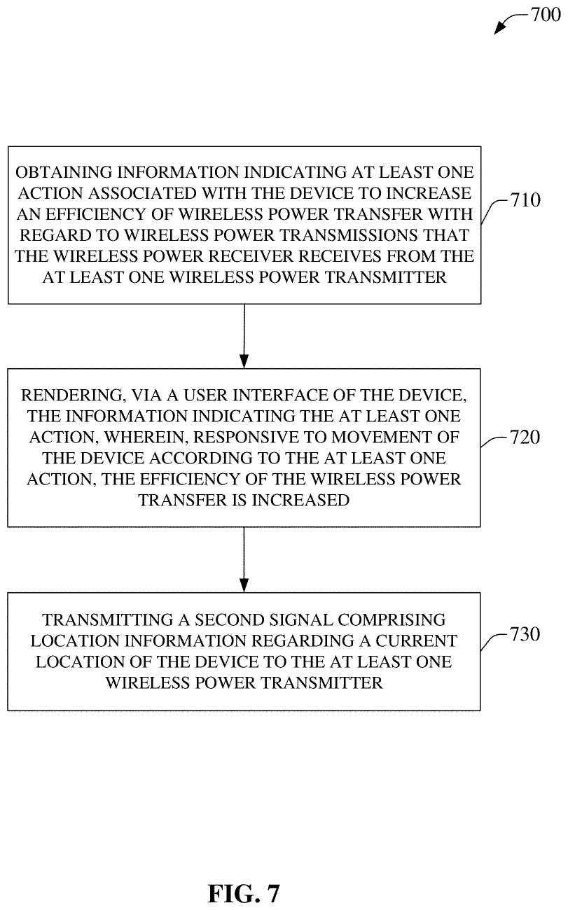

FIG. 7 illustrates an example computer readable medium comprising executable instructions that, when executed, facilitate a wireless power receiver to obtain and render movement information indicating a movement or reorientation for the wireless power receiver to undergo to improve an efficiency of power reception by the wireless power receiver, in accordance with aspects of the subject disclosure. For instance, a machine-readable storage medium can comprise executable instructions that, when executed by a processor of a device comprising a wireless power receiver, facilitate performance of operations 700.

Operations 700 comprise, at 710, obtaining information indicating at least one action associated with the device to increase an efficiency of wireless power transfer with regard to wireless power transmissions that the wireless power receiver receives from the at least one wireless power transmitter. The obtaining the information can comprise obtaining the information in response to transmitting, to the at least one wireless power transmitter, a signal comprising efficiency information regarding the efficiency of wireless power transfer.

At 720, operations 700 can comprise rendering, via a user interface of the device, the information indicating the at least one action, wherein, responsive to movement of the device according to the at least one action, the efficiency of the wireless power transfer is increased.

Optionally, operations 700 can further comprise transmitting a signal comprising location information regarding a current location of the device to the at least one wireless power transmitter.

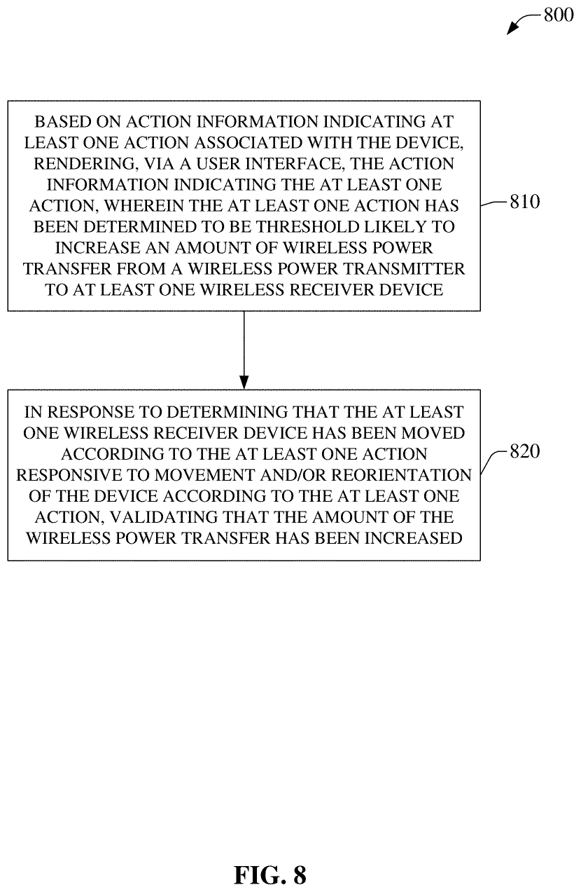

FIG. 8 illustrates an example device that obtains and renders movement information indicating a movement or reorientation for a wireless power receiver device to undergo to improve an amount of power reception by the wireless power receiver device, in accordance with aspects of the subject disclosure. The device can comprise a processor, and a memory that stores executable instructions that, when executed by the processor, facilitate performance of operations 800.

In this regard, operations 800 can comprise at 810, based on action information indicating at least one action associated with the device, rendering, via a user interface, the action information indicating the at least one action. In this regard, the at least one action has been determined to be threshold likely to increase an amount of wireless power transfer from a wireless power transmitter to at least one wireless receiver device.

At 820, operations 800 can comprise, in response to determining that the at least one wireless receiver device has been moved according to the at least one action responsive to movement of the device according to the at least one action, validating that the amount of the wireless power transfer has been increased.

The validating that the amount of the wireless power transfer has been increased can comprise determining that a number of interruptions in the wireless power transfer over a defined period of time has satisfied a criterion. Further, the determining that the number of interruptions in the wireless power transfer over the defined period of time has satisfied the criterion comprises determining that a rate of interruptions in the wireless power transfer over the defined period of time is less than a threshold rate of interruptions. Alternatively, the determining that the number of interruptions in the wireless power transfer over the defined period of time has satisfied the criterion can comprise determining that a percentage of power measurements associated with the number of interruptions for the defined period of time relative to overall power measurements for the defined period of time is less than a threshold percentage.

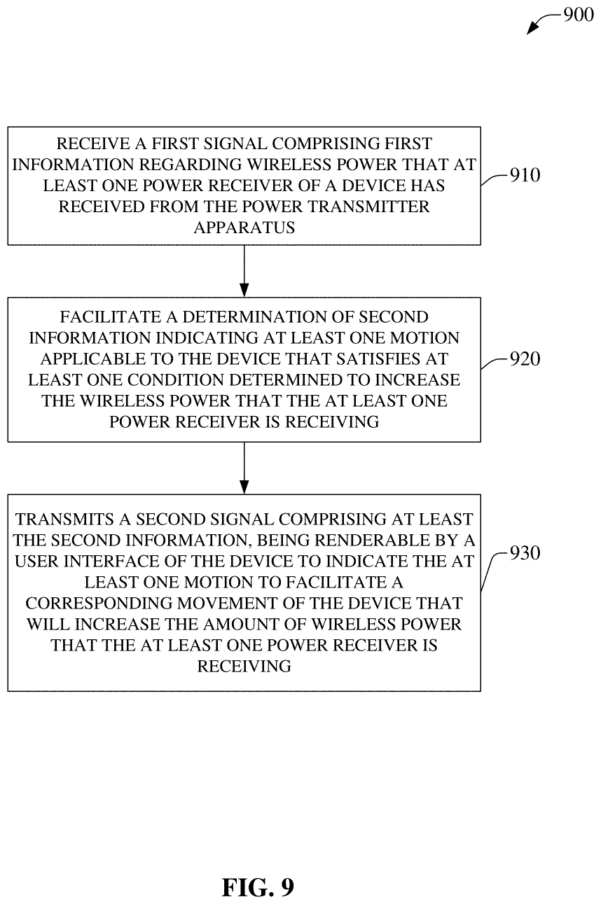

As mentioned in connection with various embodiments described above, the movement or reorientation of a wireless power receiver device can contribute to improvement in wireless power reception by the wireless power receiver device, but so can the movement or reorientation of a wireless power transmitter device, as illustrated in FIG. 9. It is also noted that movement or reorientation of the wireless power receiver and the wireless power transmitter can be performed, and thus any embodiment respecting movement and/or reorientation of the wireless power receiver can be combined with, or is exchangeable with, a similar embodiment respecting movement and/or reorientation of the wireless power transmitter. In other words, any of the foregoing embodiments applicable to the wireless power receiver are also applicable to any embodiment that guides a movement or reorientation of a wireless power transmitter to improve wireless power transfer from the wireless power transmitter to the wireless power receiver.

Highlighting this respect further at the wireless power transmitter, FIG. 9 shows an example wireless power transmission apparatus that facilitates a determination of movement information on behalf of the wireless power receiver that can be sent to the wireless power receiver to facilitate movement of the wireless power receiver to improve power reception by the wireless power receiver, in accordance with aspects of the subject disclosure.

For example, a power transmitter apparatus, such as power transmitter apparatus 110 of FIG. 1, can comprise a communication interface, such as communication interface 122 of FIG. 1, and a processor, such as processor(s) 120 of FIG. 1. In this regard, the communication interface and the processor can cooperate to perform process 900. At 910, the communication interface receives a first signal comprising first information regarding wireless power that at least one power receiver of a device has received from the power transmitter apparatus. Further, at 920 of process 900, the processor facilitates a determination of second information indicating at least one motion applicable to the device that satisfies at least one condition determined to increase the wireless power that the at least one power receiver is receiving. The communication interface can further transmit a second signal comprising at least the second information, being renderable by a user interface of the device to indicate the at least one motion to facilitate a corresponding movement of the device that will increase the amount of wireless power that the at least one power receiver is receiving.

In an embodiment, the processor of the wireless power transmitter can analyze a previous location of the device, determine a new location of the device to which to move the device to increase the amount of wireless power that the at least one power receiver is receiving, and include the new location in the second information, and the communication interface further transmits a second signal comprising at least the second information to the device, enabling the user interface to render movement information relative to the new location to facilitate a corresponding movement of the device to the new location to increase the amount of wireless power that the at least one power receiver is receiving.

In another embodiment, the processor of the wireless power transmitter can analyze a location of the device at the time of receiving the first signal, determine a trajectory of motion of the device based on past locations of the device and the location of the device, determine a new location relative to the trajectory of motion of the device to which to move the device to increase the amount of wireless power that the at least one power receiver is receiving, and include the trajectory of motion of the device and the new location in the second information. In addition, the communication interface can then transmit a second signal comprising at least the second information to the device enabling a user interface to render movement information relative to the trajectory of motion of the device to facilitate a corresponding movement of the device to the new location to increase the amount of wireless power that the at least one power receiver is receiving.

In one non-limiting aspect, the communication interface can receive a third signal from at least one other device wirelessly connected to the power transmitter apparatus and connected to the device, the third signal comprising third information indicating that a location of the device is different from where the device was located when the first signal was received from the device. The communication interface can further receive, from the at least one other device, third information comprising a new location of the device to which to move the device to increase the amount of wireless power that the at least one power receiver is receiving, and include the new location in the second information that is sent to the device in the second signal comprising at least the second information to the device, enabling the user interface to render the movement information relative to the new location to facilitate the corresponding movement of the device to the new location to increase the amount of wireless power that the at least one power receiver is receiving.

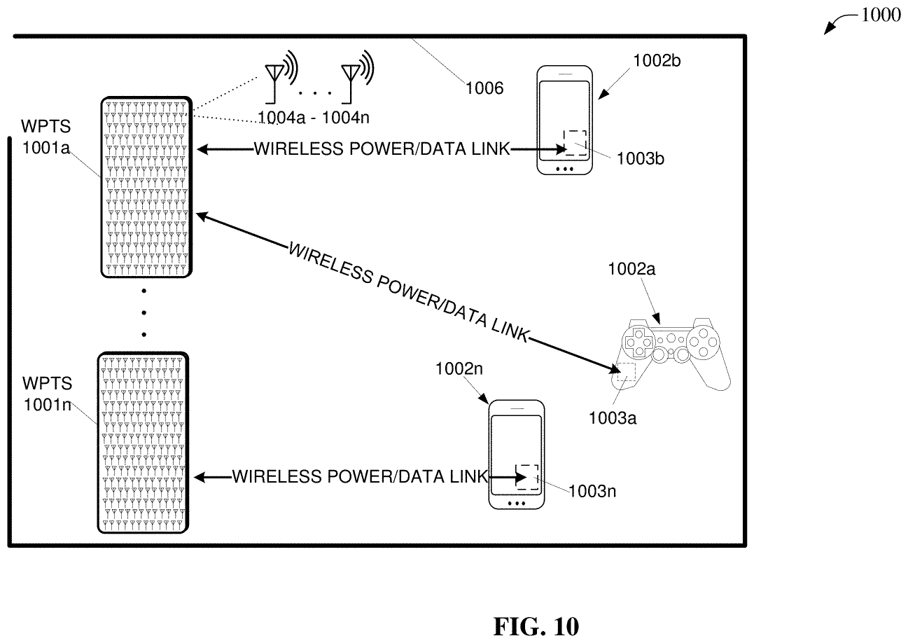

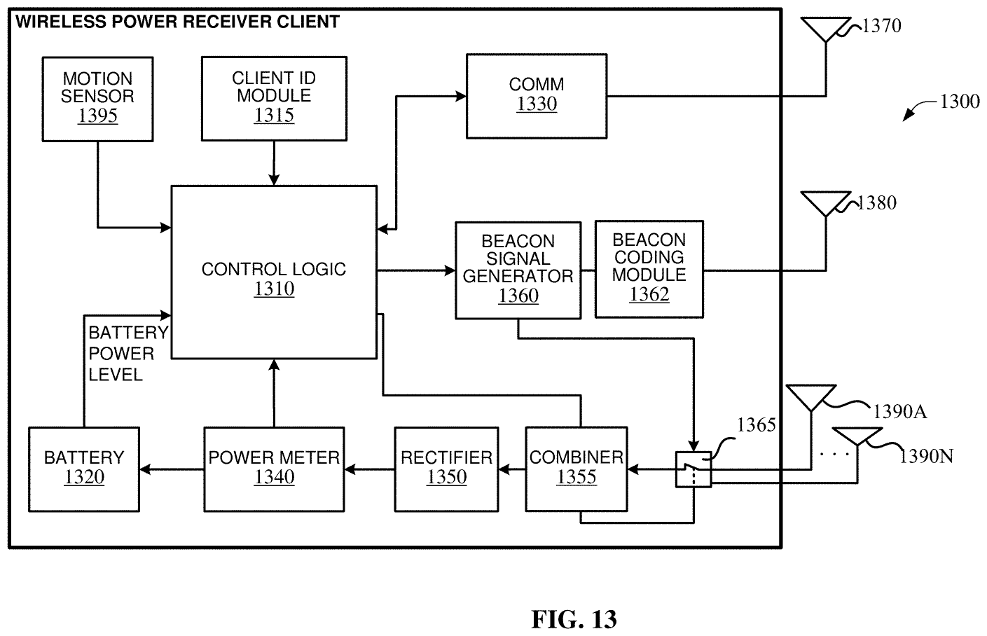

FIG. 10 depicts a block diagram including an example wireless power delivery environment 1000 illustrating wireless power delivery from one or more wireless power transmission systems (WPTS) 1001a-n (also referred to as “wireless power delivery systems”, “antenna array systems” and “wireless chargers”) to various wireless devices 1002a-n within the wireless power delivery environment 1000, according to some embodiments. More specifically, FIG. 10 illustrates an example wireless power delivery environment 1000 in which wireless power and/or data can be delivered to available wireless devices 1002a-1002n having one or more wireless power receiver clients 1003a-1003n (also referred to herein as “clients” and “wireless power receivers”). The wireless power receiver clients are configured to receive and process wireless power from one or more wireless power transmission systems 1001a-1001n. Components of an example wireless power receiver client 1003 are shown and discussed in greater detail with reference to FIG. 13.

As shown in the example of FIG. 10, the wireless devices 1002a-1002n include mobile phone devices and a wireless game controller. However, the wireless devices 1002a-1002n can be any device or system that needs power and is capable of receiving wireless power via one or more integrated wireless power receiver clients 1003a-1003n. As discussed herein, the one or more integrated wireless power receiver clients receive and process power from one or more wireless power transmission systems 1001a-1001n and provide the power to the wireless devices 1002a-1002n (or internal batteries of the wireless devices) for operation thereof.

Each wireless power transmission system 1001 can include multiple antennas 1004a-n, e.g., an antenna array including hundreds or thousands of antennas, which are capable of delivering wireless power to wireless devices 1002a-1002n. In some embodiments, the antennas are adaptively-phased RF antennas. The wireless power transmission system 1001 is capable of determining the appropriate phases with which to deliver a coherent power transmission signal to the wireless power receiver clients 1003a-1003n. The array is configured to emit a signal (e.g., continuous wave or pulsed power transmission signal) from multiple antennas at a specific phase relative to each other. It is appreciated that use of the term “array” does not necessarily limit the antenna array to any specific array structure. That is, the antenna array does not need to be structured in a specific “array” form or geometry. Furthermore, as used herein the term “array” or “array system” may include related and peripheral circuitry for signal generation, reception and transmission, such as radios, digital logic and modems. In some embodiments, the wireless power transmission system 1001 can have an embedded WiFi hub for data communications via one or more antennas or transceivers.

The wireless devices 1002 can include one or more wireless power receiver clients 1003. As illustrated in the example of FIG. 10, power delivery antennas 1004a-1004n are shown. The power delivery antennas 1004a are configured to provide delivery of wireless radio frequency power in the wireless power delivery environment. In some embodiments, one or more of the power delivery antennas 1004a-1004n can alternatively or additionally be configured for data communications in addition to or in lieu of wireless power delivery. The one or more data communication antennas are configured to send data communications to and receive data communications from the wireless power receiver clients 1003a-1003n and/or the wireless devices 1002a-1002n. In some embodiments, the data communication antennas can communicate via Bluetooth™, WiFi™, ZigBee™, etc. Other data communication protocols are also possible.

Each wireless power receiver client 1003a-1003n includes one or more antennas (not shown) for receiving signals from the wireless power transmission systems 1001a-1001n. Likewise, each wireless power transmission system 1001a-1001n includes an antenna array having one or more antennas and/or sets of antennas capable of emitting continuous wave or discrete (pulse) signals at specific phases relative to each other. As discussed above, each of the wireless power transmission systems 1001a-1001n is capable of determining the appropriate phases for delivering the coherent signals to the wireless power receiver clients 1002a-1002n. For example, in some embodiments, coherent signals can be determined by computing the complex conjugate of a received beacon (or calibration) signal at each antenna of the array such that the coherent signal is phased for delivering power to the particular wireless power receiver client that transmitted the beacon (or calibration) signal.

Although not illustrated, each component of the environment, e.g., wireless device, wireless power transmission system, etc., can include control and synchronization mechanisms, e.g., a data communication synchronization module. The wireless power transmission systems 1001a-1001n can be connected to a power source such as, for example, a power outlet or source connecting the wireless power transmission systems to a standard or primary AC power supply in a building. Alternatively, or additionally, one or more of the wireless power transmission systems 1001a-1001n can be powered by a battery or via other mechanisms, e.g., solar cells, etc.

The wireless power receiver clients 1002a-1002n and/or the wireless power transmission systems 1001a-1001n are configured to operate in a multipath wireless power delivery environment. That is, the wireless power receiver clients 1002a-1002n and the wireless power transmission systems 1001a-1001n are configured to utilize reflective objects 1006 such as, for example, walls or other RF reflective obstructions within range to transmit beacon (or calibration) signals and/or receive wireless power and/or data within the wireless power delivery environment. The reflective objects 1006 can be utilized for multi-directional signal communication regardless of whether a blocking object is in the line of sight between the wireless power transmission system and the wireless power receiver clients 1003a-1003n.

As described herein, each wireless device 1002a-1002n can be any system and/or device, and/or any combination of devices/systems that can establish a connection with another device, a server and/or other systems within the example environment 1000. In some embodiments, the wireless devices 1002a-1002n include displays or other output functionalities to present data to a user and/or input functionalities to receive data from the user. By way of example, a wireless device 1002 can be, but is not limited to, a video game controller, a server desktop, a desktop computer, a computer cluster, a mobile computing device such as a notebook, a laptop computer, a handheld computer, a mobile phone, a smart phone, a PDA, a Blackberry device, a Treo, and/or an iPhone, etc. By way of example and not limitation, the wireless device 1002 can also be any wearable device such as watches, necklaces, rings or even devices embedded on or within the customer. Other examples of a wireless device 1002 include, but are not limited to, safety sensors (e.g., fire or carbon monoxide), electric toothbrushes, electronic door lock/handles, electric light switch controller, electric shavers, etc.

Although not illustrated in the example of FIG. 10, the wireless power transmission system 1001 and the wireless power receiver clients 1003a-1003n can each include a data communication module for communication via a data channel. Alternatively, or additionally, the wireless power receiver clients 1003a-1003n can direct the wireless devices 1002a-1002n to communicate with the wireless power transmission system via existing data communications modules. In some embodiments, the beacon signal, which is primarily referred to herein as a continuous waveform, can alternatively or additionally take the form of a modulated signal.

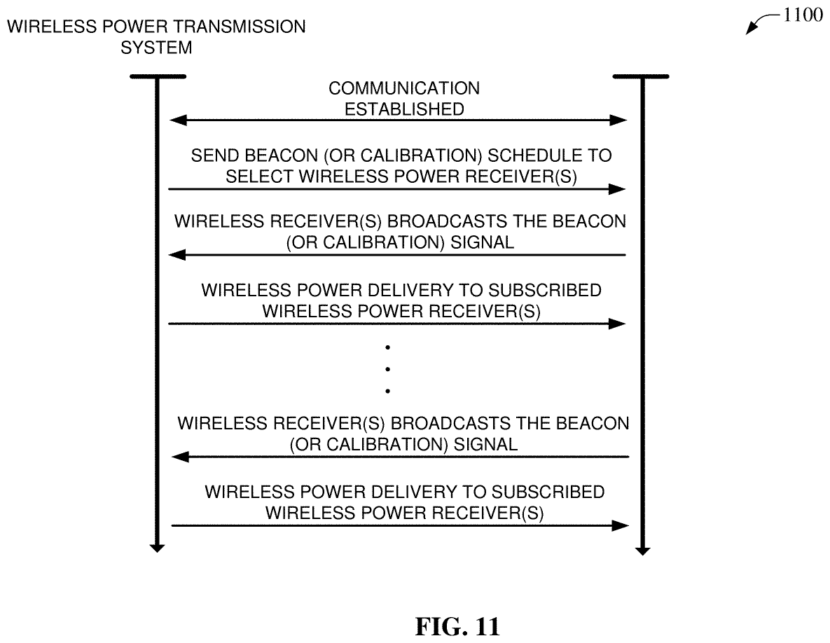

FIG. 11 depicts a sequence diagram 1100 illustrating example operations between a wireless power delivery system, e.g., wireless power transmission apparatus 110, etc., and a wireless power receiver client 1003, e.g., wireless power receiving device 130, etc., for establishing wireless power delivery in a multipath wireless power delivery, according to an embodiment. Initially, communication is established between the wireless power delivery system and the power receiver client. The initial communication can be, for example, a data communication link that is established via one or more antennas (e.g., 1004a-1004n) of the wireless power transmission system. As discussed, in some embodiments, one or more of the antennas can be data antennas, wireless power transmission antennas, or dual-purpose data/power antennas. Various information can be exchanged between the wireless power transmission system and the wireless power receiver client over this data communication channel. For example, wireless power signaling can be time sliced among various clients in a wireless power delivery environment. In such cases, the wireless power transmission system can send beacon schedule information, e.g., Beacon Beat Schedule (BBS) cycle, power cycle information, etc., so that the wireless power receiver client knows when to transmit (broadcast) its beacon signals and when to listen for power, etc.

Continuing with the example of FIG. 11, the wireless power transmission system selects one or more wireless power receiver clients for receiving power and sends the beacon schedule information to the selected wireless power receiver clients. The wireless power transmission system can also send power transmission scheduling information so that the wireless power receiver client knows when to expect (e.g., a window of time) wireless power from the wireless power transmission system. The wireless power receiver client then generates a beacon (or calibration) signal and broadcasts the beacon during an assigned beacon transmission window (or time slice) indicated by the beacon schedule information, e.g., BBS cycle. As discussed herein, the wireless power receiver client includes one or more antennas (or transceivers) that have a radiation and reception pattern in three-dimensional space proximate to the wireless device in which the wireless power receiver client is embedded.

The wireless power transmission system receives the beacon from the power receiver client and detects and/or otherwise measures the phase (or direction) from which the beacon signal is received at multiple antennas. The wireless power transmission system then delivers wireless power to the power receiver client from the multiple antennas based on the detected or measured phase (or direction) of the received beacon at each of the corresponding antennas. In some embodiments, the wireless power transmission system determines the complex conjugate of the measured phase of the beacon and uses the complex conjugate to determine a transmit phase that configures the antennas for delivering and/or otherwise directing wireless power to the wireless power receiver client via the same path over which the beacon signal was received from the wireless power receiver client.

In some embodiments, the wireless power transmission system includes many antennas. One or more of the many antennas may be used to deliver power to the power receiver client. The wireless power transmission system can detect and/or otherwise determine or measure phases at which the beacon signals are received at each antenna. The large number of antennas may result in different phases of the beacon signal being received at each antenna of the wireless power transmission system. As discussed above, the wireless power transmission system can determine the complex conjugate of the beacon signals received at each antenna. Using the complex conjugates, one or more antennas may emit a signal that takes into account the effects of the large number of antennas in the wireless power transmission system. In other words, the wireless power transmission system can emit a wireless power transmission signal from one or more antennas in such a way as to create an aggregate signal from the one or more of the antennas that approximately recreates the waveform of the beacon in the opposite direction. Said another way, the wireless power transmission system can deliver wireless RF power to the wireless power receiver clients via the same paths over which the beacon signal is received at the wireless power transmission system. These paths can utilize reflective objects 1006 within the environment. Additionally, the wireless power transmission signals can be simultaneously transmitted from the wireless power transmission system such that the wireless power transmission signals collectively match the antenna radiation and reception pattern of the client device in a three-dimensional (3D) space proximate to the client device.

As shown, the beacon (or calibration) signals can be periodically transmitted by wireless power receiver clients within the power delivery environment according to, for example, the BBS, so that the wireless power transmission system can maintain knowledge and/or otherwise track the location of the power receiver clients in the wireless power delivery environment. The process of receiving beacon signals from a wireless power receiver client at the wireless power transmission system and, in turn, responding with wireless power directed to that particular wireless power receiver client is referred to herein as retrodirective wireless power delivery.

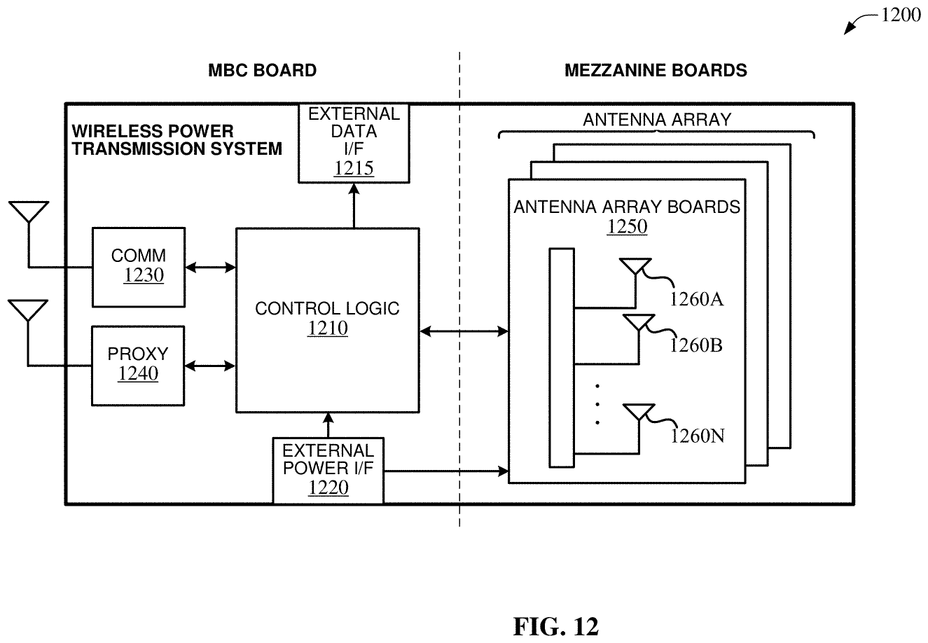

Furthermore, as discussed herein, wireless power can be delivered in power cycles defined by power schedule information. A more detailed example of the signaling required to commence wireless power delivery is described now with reference to FIG. 12.

FIG. 12 depicts a block diagram illustrating example components of a wireless power transmission system 1200, in accordance with an embodiment. As illustrated in the example of FIG. 12, the wireless power transmission system 1200 includes a master bus controller (MBC) board and multiple mezzanine boards that collectively comprise the antenna array.

The MBC includes control logic 1210, an external data interface (I/F) 1215, an external power interface (I/F) 1220, a communication block 1230 and proxy 1240. The mezzanine boards (or antenna array boards 1250) each include multiple antennas 1260a-1260n. Some or all of the components can be omitted in some embodiments. Additional components are also possible. For example, in some embodiments only one of communication block 1230 or proxy 1240 may be included.

The control logic 1210 is configured to provide control and intelligence to the array components. The control logic 1210 may comprise one or more processors, FPGAs, memory units, etc., and direct and control the various data and power communications. The communication block 1230 can direct data communications on a data carrier frequency, such as the base signal clock for clock synchronization. The data communications can be Bluetooth™, WiFi™, ZigBee™, etc., including combinations or variations thereof. Likewise, the proxy 1240 can communicate with clients via data communications as discussed herein. The data communications can be, by way of example and not limitation, Bluetooth™, WiFi™, ZigBee™, etc. Other communication protocols are possible.

In some embodiments, the control logic 1210 can also facilitate and/or otherwise enable data aggregation for Internet of Things (IoT) devices. In some embodiments, wireless power receiver clients can access, track and/or otherwise obtain IoT information about the device in which the wireless power receiver client is embedded and provide that IoT information to the wireless power transmission system over a data connection. This IoT information can be provided to via an external data interface 1215 to a central or cloud-based system (not shown) where the data can be aggregated, processed, etc. For example, the central system can process the data to identify various trends across geographies, wireless power transmission systems, environments, devices, etc. In some embodiments, the aggregated data and or the trend data can be used to improve operation of the devices via remote updates, etc. Alternatively, or additionally, in some embodiments, the aggregated data can be provided to third party data consumers. In this manner, the wireless power transmission system acts as a Gateway or Enabler for the IoT devices. By way of example and not limitation, the IoT information can include capabilities of the device in which the wireless power receiver client is embedded, usage information of the device, power levels of the device, information obtained by the device or the wireless power receiver client itself, e.g., via sensors, etc.

The external power interface 1220 is configured to receive external power and provide the power to various components. In some embodiments, the external power interface 1220 may be configured to receive a standard external 24 Volt power supply. In other embodiments, the external power interface can be, for example, 120/240 Volt alternating current (AC) mains to an embedded direct current (DC) power supply that sources the required 12/24/48 Volt DC to provide the power to various components. Alternatively, the external power interface could be a DC supply that sources the required 12/24/48 Volts DC. Alternative configurations are also possible.

In operation, the MBC, which controls the wireless power transmission system, receives power from a power source and is activated. The MBC then activates proxy antenna elements on the wireless power transmission system and the proxy antenna elements enter a default “discovery” mode to identify available wireless receiver clients within range of the wireless power transmission system. When a client is found, the antenna elements on the wireless power transmission system power on, enumerate, and (optionally) calibrate.

The MBC then generates beacon transmission scheduling information and power transmission scheduling information during a scheduling process. The scheduling process includes selection of power receiver clients. For example, the MBC can select power receiver clients for power transmission and generate a BBS cycle and a Power Schedule (PS) for the selected wireless power receiver clients. As discussed herein, the power receiver clients can be selected based on their corresponding properties and/or requirements.

In some embodiments, the MBC can also identify and/or otherwise select available clients that will have their status queried in the Client Query Table (CQT). Clients that are placed in the CQT are those on “standby”, e.g., not receiving a charge. The BBS and PS are calculated based on vital information about the clients such as, for example, battery status, current activity/usage, how much longer the client has until it runs out of power, priority in terms of usage, etc.

The Proxy Antenna Element (AE) broadcasts the BBS to all clients. As discussed herein, the BBS indicates when each client should send a beacon. Likewise, the PS indicates when and to which clients the array should send power to and when clients should listen for wireless power. Each client starts broadcasting its beacon and receiving power from the array per the BBS and PS. The Proxy AE can concurrently query the Client Query Table to check the status of other available clients. In some embodiments, a client can only exist in the BBS or the CQT (e.g., waitlist), but not in both. The information collected in the previous step continuously and/or periodically updates the BBS cycle and/or the PS.

FIG. 13 is a block diagram illustrating example components of a wireless power receiver client 1300, in accordance with some embodiments. As illustrated in the example of FIG. 13, the wireless power receiver client 1300 includes control logic 1310, battery 1320, an IoT control module 1325, communication block 1330 and associated antenna 1370, power meter 1340, rectifier 1350, a combiner 1355, beacon signal generator 1360, beacon coding unit 1362 and an associated antenna 1380, and switch 1365 connecting the rectifier 1350 or the beacon signal generator 1360 to one or more associated antennas 1390a-n. Some or all of the components can be omitted in some embodiments. For example, in some embodiments, the wireless power receiver client 1300 does not include its own antennas but instead utilizes and/or otherwise shares one or more antennas (e.g., WiFi antenna) of the wireless device, e.g., example device 110, 210, etc., in which the wireless power receiver client is embedded. Moreover, in some embodiments, the wireless power receiver client may include a single antenna that provides data transmission functionality as well as power/data reception functionality. Additional components are also possible.

A combiner 1355 receives and combines the received power transmission signals from the power transmitter in the event that the receiver 1300 has more than one antenna. The combiner can be any combiner or divider circuit that is configured to achieve isolation between the output ports while maintaining a matched condition. For example, the combiner 1355 can be a Wilkinson Power Divider circuit. The rectifier 1350 receives the combined power transmission signal from the combiner 1355, if present, which is fed through the power meter 1340 to the battery 1320 for charging. In other embodiments, each antenna's power path can have its own rectifier 1350 and the DC power out of the rectifiers is combined prior to feeding the power meter 1340. The power meter 1340 can measure the received power signal strength and provides the control logic 1310 with this measurement.

Battery 1320 can include protection circuitry and/or monitoring functions. Additionally, the battery 1320 can include one or more features, including, but not limited to, current limiting, temperature protection, over/under voltage alerts and protection, and coulomb monitoring.

The control logic 1310 receives and processes the battery power level from the battery 1320 itself. The control logic 1310 may also transmit/receive via the communication block 1330 a data signal on a data carrier frequency, such as the base signal clock for clock synchronization. The beacon signal generator 1360 generates the beacon signal, or calibration signal, transmits the beacon signal using either the antenna 1380 or 1390 after the beacon signal is encoded.

It may be noted that, although the battery 1320 is shown as charged by, and providing power to, the wireless power receiver client 1300, the receiver may also receive its power directly from the rectifier 1350. This may be in addition to the rectifier 1350 providing charging current to the battery 1320, or in lieu of providing charging. Also, it may be noted that the use of multiple antennas is one example of implementation and the structure may be reduced to one shared antenna.

In some embodiments, the control logic 1310 and/or the IoT control module 1325 can communicate with and/or otherwise derive IoT information from the device in which the wireless power receiver client 1300 is embedded. Although not shown, in some embodiments, the wireless power receiver client 1300 can have one or more data connections (wired or wireless) with the device in which the wireless power receiver client 1300 is embedded over which IoT information can be obtained. Alternatively, or additionally, IoT information can be determined and/or inferred by the wireless power receiver client 1300, e.g., via one or more sensors. As discussed above, the IoT information can include, but is not limited to, information about the capabilities of the device in which the wireless power receiver client 1300 is embedded, usage information of the device in which the wireless power receiver client 1300 is embedded, power levels of the battery or batteries of the device in which the wireless power receiver client 1300 is embedded, and/or information obtained or inferred by the device in which the wireless power receiver client is embedded or the wireless power receiver client itself, e.g., via sensors, etc.

In some embodiments, a client identifier (ID) module 1315 stores a client ID that can uniquely identify the wireless power receiver client 1300 in a wireless power delivery environment. For example, the ID can be transmitted to one or more wireless power transmission systems when communication is established. In some embodiments, wireless power receiver clients may also be able to receive and identify other wireless power receiver clients in a wireless power delivery environment based on the client ID.

An optional motion sensor 1395 can detect motion and signal the control logic 1310 to act accordingly. For example, a device receiving power may integrate motion detection mechanisms such as accelerometers or equivalent mechanisms to detect motion. Once the device detects that it is in motion, it may be assumed that it is being handled by a user, and would trigger a signal to the array to either to stop transmitting power, or to lower the power transmitted to the device. In some embodiments, when a device is used in a moving environment like a car, train or plane, the power might only be transmitted intermittently or at a reduced level unless the device is critically low on power.

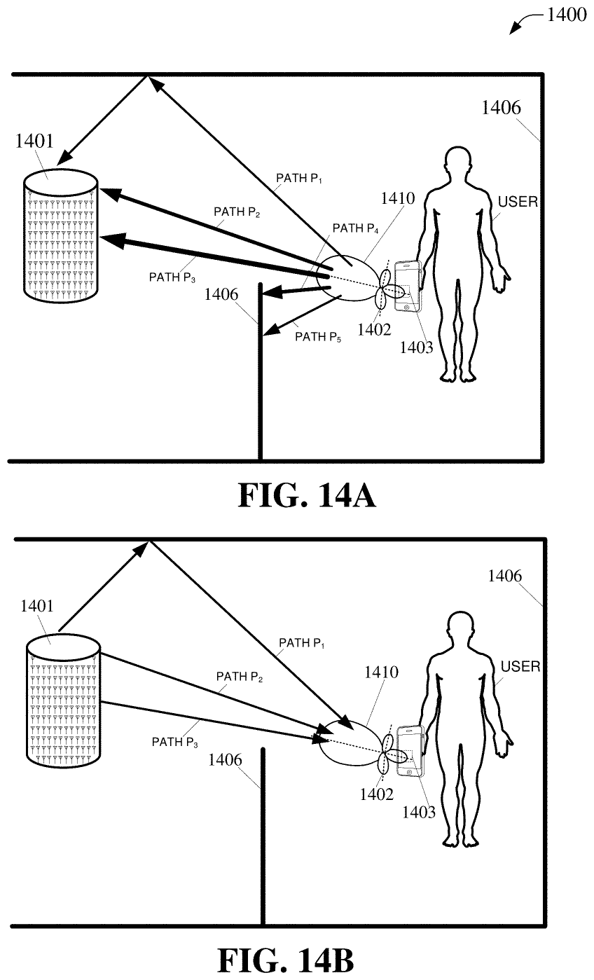

FIG. 14A and FIG. 14B depict diagrams illustrating an example multipath wireless power delivery environment 1400, according to some embodiments. The multipath wireless power delivery environment 1400 includes a user operating a wireless device, e.g., example device 130, etc., including one or more wireless power receiver clients (e.g., 1403). The wireless device 1402 can be example device 130, etc., and the one or more wireless power receiver clients 1403 can be the wireless power receiver client 1003 or the wireless power receiver client 1300, although alternative configurations are possible. Likewise, wireless power transmission system 1401 can be wireless power transmission system 1001 or wireless power transmission system 1200, although alternative configurations are possible. The multipath wireless power delivery environment 1400 includes reflective objects 1406 and various absorptive objects, e.g., users, or humans, furniture, etc.

Wireless device 1402 includes one or more antennas (or transceivers) that have a radiation and reception pattern 1410 in three-dimensional space proximate to the wireless device 1402. The one or more antennas (or transceivers) can be wholly or partially included as part of the wireless device 1402 and/or the wireless power receiver client (not shown). For example, in some embodiments one or more antennas, e.g., WiFi, Bluetooth, etc. of the wireless device 1402 can be utilized and/or otherwise shared for wireless power reception. As shown in the examples of FIG. 14A and FIG. 14B, the radiation and reception pattern 1410 comprises a lobe pattern with a primary lobe and multiple side lobes. Other patterns are also possible.

The wireless device 1402 transmits a beacon (or calibration) signal over multiple paths to the wireless power transmission system 1401. As discussed herein, the wireless device 1402 transmits the beacon in the direction of the radiation and reception pattern 1410 such that the strength of the received beacon signal by the wireless power transmission system, e.g., received signal strength indication (RSSI), depends on the radiation and reception pattern 1410. For example, beacon signals are not transmitted where there are nulls in the radiation and reception pattern 1410 and beacon signals are the strongest at the peaks in the radiation and reception pattern 1410, e.g., peak of the primary lobe. As shown in the example of FIG. 14A, the wireless device 1402 transmits beacon signals over five paths P1-P5. Paths P4 and P5 are blocked by reflective and/or absorptive object 1406. The wireless power transmission system 1401 receives beacon signals of increasing strengths via paths P1-P3. The bolder lines indicate stronger signals. In some embodiments, the beacon signals are directionally transmitted in this manner, for example, to avoid unnecessary RF energy exposure to the user.

A fundamental property of antennas is that the receiving pattern (sensitivity as a function of direction) of an antenna when used for receiving is identical to the far-field radiation pattern of the antenna when used for transmitting. This is a consequence of the reciprocity theorem in electromagnetism. As shown in the example of FIG. 14A and FIG. 14B, the radiation and reception pattern 1410 is a three-dimensional lobe shape. However, the radiation and reception pattern 1410 can be any number of shapes depending on the type or types, e.g., horn antennas, simple vertical antenna, etc. used in the antenna design. For example, the radiation and reception pattern 1410 can comprise various directive patterns. Any number of different antenna radiation and reception patterns are possible for each of multiple client devices in a wireless power delivery environment.

Referring again to FIG. 14A, the wireless power transmission system 1401 receives the beacon (or calibration) signal via multiple paths P1-P3 at multiple antennas or transceivers. As shown, paths P2 and P3 are direct line of sight paths while path P1 is a non-line of sight path. Once the beacon (or calibration) signal is received by the wireless power transmission system 1401, the power transmission system 1401 processes the beacon (or calibration) signal to determine one or more receive characteristics of the beacon signal at each of the multiple antennas. For example, among other operations, the wireless power transmission system 1401 can measure the phases at which the beacon signal is received at each of the multiple antennas or transceivers.

The wireless power transmission system 1401 processes the one or more receive characteristics of the beacon signal at each of the multiple antennas to determine or measure one or more wireless power transmit characteristics for each of the multiple RF transceivers based on the one or more receive characteristics of the beacon (or calibration) signal as measured at the corresponding antenna or transceiver. By way of example and not limitation, the wireless power transmit characteristics can include phase settings for each antenna or transceiver, transmission power settings, etc.

As discussed herein, the wireless power transmission system 1401 determines the wireless power transmit characteristics such that, once the antennas or transceivers are configured, the multiple antennas or transceivers are operable to transit a wireless power signal that matches the client radiation and reception pattern in the three-dimensional space proximate to the client device. FIG. 14B illustrates the wireless power transmission system 1401 transmitting wireless power via paths P1-P3 to the wireless device 1402. Advantageously, as discussed herein, the wireless power signal matches the client radiation and reception pattern 1410 in the three-dimensional space proximate to the client device. Said another way, the wireless power transmission system will transmit the wireless power signals in the direction in which the wireless power receiver has maximum gain, e.g., will receive the most wireless power. As a result, no signals are sent in directions in which the wireless power receiver cannot receive power, e.g., nulls and blockages. In some embodiments, the wireless power transmission system 1401 measures the RSSI of the received beacon signal and if the beacon is less than a threshold value, the wireless power transmission system will not send wireless power over that path.

The three paths shown in the examples of FIG. 14A and FIG. 14B are illustrated for simplicity, it is appreciated that any number of paths can be utilized for transmitting power to the wireless device 1402 depending on, among other factors, reflective and absorptive objects in the wireless power delivery environment. Although the example of FIG. 14A illustrates transmitting a beacon (or calibration) signal in the direction of the radiation and reception pattern 1410, it is appreciated that, in some embodiments, beacon signals can alternatively or additionally be omni-directionally transmitted.

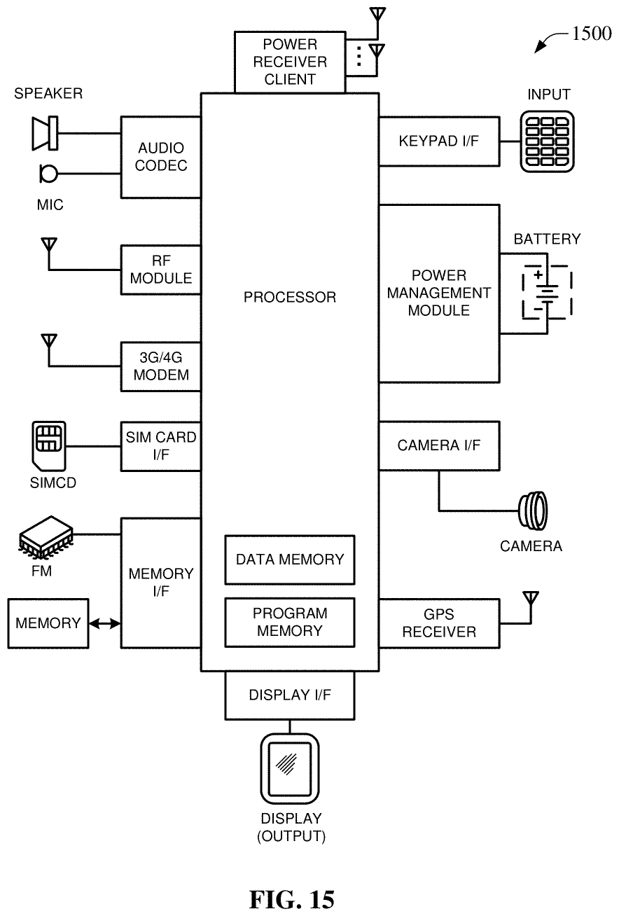

FIG. 15 depicts a block diagram illustrating example components of a representative mobile device, e.g., example device 110, 210, etc., or tablet computer 1500 with a wireless power receiver or client in the form of a mobile (or smart) phone or tablet computer device, according to an embodiment. Various interfaces and modules are shown with reference to FIG. 15, however, the mobile device or tablet computer does not require all of modules or functions for performing the functionality described herein. It is appreciated that, in many embodiments, various components are not included and/or necessary for operation of the category controller. For example, components such as GPS radios, cellular radios, and accelerometers may not be included in the controllers to reduce costs and/or complexity. Additionally, components such as ZigBee radios and RF identification (RFID) transceivers, along with antennas, can populate a PCB.

The wireless power receiver client can be a power receiver client 1003 of FIG. 10, although alternative configurations are possible. Additionally, the wireless power receiver client can include one or more RF antennas for reception of power and/or data signals from a charger, e.g., WPTS 1001 of FIG. 10.

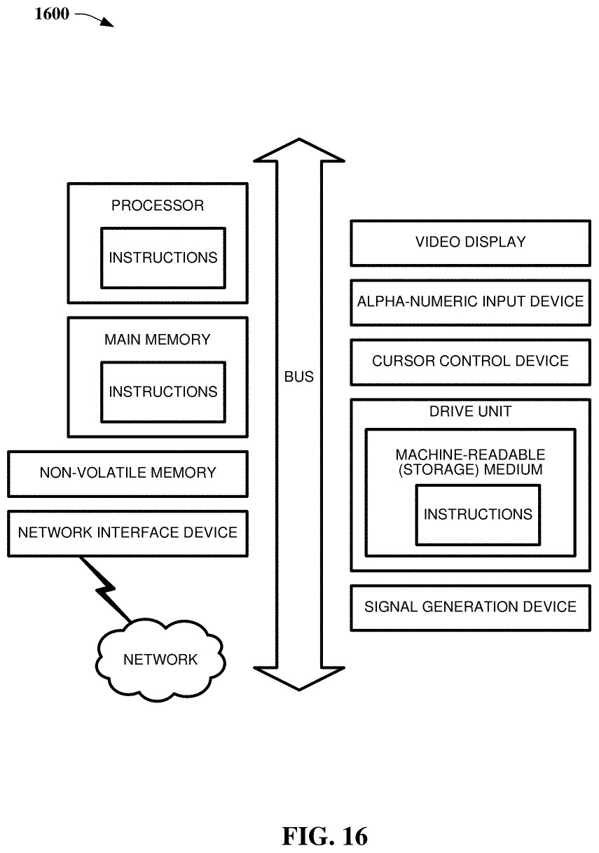

FIG. 16 depicts a diagrammatic representation of a machine, in the example form, of a computer system within which a set of instructions, for causing the machine to perform any one or more of the methodologies discussed herein, may be executed.

In the example of FIG. 16, the computer system includes a processor, memory, non-volatile memory, and an interface device. Various common components (e.g., cache memory) are omitted for illustrative simplicity. The computer system 1600 is intended to illustrate a hardware device on which any of the components depicted in the example of FIG. 10 (and any other components described in this specification) can be implemented. For example, the computer system can be any radiating object or antenna array system. The computer system can be of any applicable known or convenient type. The components of the computer system can be coupled together via a bus or through some other known or convenient device.

The processor may be, for example, a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor.

The memory is coupled to the processor by, for example, a bus. The memory can include, by way of example but not limitation, random access memory (RAM), such as dynamic RAM (DRAM) and static RAM (SRAM). The memory can be local, remote, or distributed.

The bus also couples the processor to the non-volatile memory and drive unit. The non-volatile memory is often a magnetic floppy or hard disk, a magnetic-optical disk, an optical disk, a read-only memory (ROM), such as a compact disk ROM (CD-ROM), electrically programmable ROM (EPROM), or electrically erasable ROM (EEPROM), a magnetic or optical card, or another form of storage for large amounts of data. Some of this data is often written, by a direct memory access process, into memory during execution of software in the computer 1600. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software is typically stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium”. A processor is considered to be “configured to execute a program” when at least one value associated with the program is stored in a register readable by the processor.

The bus also couples the processor to the network interface device. The interface can include one or more of a modem or network interface. It will be appreciated that a modem or network interface can be considered to be part of the computer system. The interface can include an analog modem, an integrated services digital network (ISDN) modem, cable modem, token ring interface, satellite transmission interface (e.g. “direct PC”), or other interfaces for coupling a computer system to other computer systems. The interface can include one or more input and/or output (I/O) devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device. For simplicity, it is assumed that controllers of any devices not depicted in the example of FIG. 16 reside in the interface.

In operation, the computer system 1600 can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. Additionally, a processing component can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions and/or processes described herein. A processing component can exploit nano-scale architectures such as, but not limited to, molecular and quantum-dot based transistors, switches and gates, in order to optimize space usage or enhance performance of components described herein. Further, a processing component can also be implemented as a combination of computing processing units.

In the subject specification, term “memory component” and substantially any other information storage component relevant to operation and functionality of a component and/or process described herein, refer to entities embodied in a “memory,” or components comprising the memory. It will be appreciated that a memory component described herein can be either volatile memory or nonvolatile memory, or can include both volatile and nonvolatile memory.

By way of illustration, and not limitation, nonvolatile memory, for example, can be included in ROM, programmable ROM (PROM), EPROM, EPROM, or flash memory. Volatile memory can include RAM, which acts as external cache memory. By way of illustration and not limitation, RAM is available in many forms such as SRAM, DRAM, synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Aspects of systems, apparatus, and processes explained herein can constitute machine-executable instructions embodied within a machine, e.g., embodied in a computer readable medium (or media) associated with the machine. Such instructions, when executed by the machine, can cause the machine to perform the operations described. Additionally, systems, processes, process blocks, etc. can be embodied within hardware, such as an application specific integrated circuit (ASIC) or the like. Moreover, the order in which some or all of the process blocks appear in each process should not be deemed limiting. Rather, it should be understood by a person of ordinary skill in the art having the benefit of the instant disclosure that some of the process blocks can be executed in a variety of orders not illustrated.

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components.

In addition, the term “or” is typically intended to mean an inclusive “or” rather than an exclusive “or.” That is, unless specified otherwise, or clear from context, “X employs A or B” is intended to mean any of the natural inclusive permutations. That is, if X employs A alone, X employs B alone, X employs C alone, X employs A and B alone, X employs B and C alone, X employs A and C alone, or X employs A and B and C, then “X employs A, B or C” is satisfied under any of the foregoing instances. Moreover, articles “a” and “an” as used in the subject specification and annexed drawings should generally be construed to mean “one or more” unless specified otherwise or clear from context to be directed to a singular form. Moreover, the use of any particular embodiment or example in the present disclosure should not be treated as exclusive of any other particular embodiment or example, unless expressly indicated as such, e.g., a first embodiment that has aspect A but not aspect B, and a second embodiment that has aspect B but not aspect A, does not preclude a third embodiment that has aspect A and aspect B. The use of granular examples and embodiments is intended to simplify understanding of certain features, aspects, etc., of the disclosed subject matter and is not intended to limit the disclosure to said granular instances of the disclosed subject matter or to illustrate that combinations of embodiments of the disclosed subject matter were not contemplated at the time of actual or constructive reduction to practice.

Further, the word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art having the benefit of the instant disclosure.

Further, the term “include,” “has,” “contains,” or other similar terms, are intended to be employed as an open or inclusive term, rather than a closed or exclusive term. The term “include” can be substituted with the term “comprising” and is to be treated with similar scope, unless otherwise explicitly used otherwise. As an example, “a basket of fruit including an apple” is to be treated with the same breadth of scope as, “a basket of fruit comprising an apple.”

Moreover, terms like “user equipment (UE),” “mobile station,” “mobile,” subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “access point,” “base station,” “Node B,” “evolved Node B,” “eNodeB,” “home Node B,” “home access point,” and the like, are utilized interchangeably in the subject application, and refer to a wireless network component or appliance that serves and receives data, control, voice, video, sound, gaming, or substantially any data-stream or signaling-stream to and from a set of subscriber stations or provider enabled devices. Data and signaling streams can comprise packetized or frame-based flows. Data or signal information exchange can comprise technology, such as, single user (SU) multiple-input and multiple-output (MIMO) (SU MIMO) radio(s), multiple user (MU) MIMO (MU MIMO) radio(s), long-term evolution (LTE), LTE time-division duplexing (TDD), global system for mobile communications (GSM), GSM EDGE Radio Access Network (GERAN), Wi Fi, WLAN, WiMax, CDMA2000, LTE new radio-access technology (LTE-NX), massive MIMO systems, etc.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities, machine learning components, or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks comprise broadcast technologies (e.g., sub-Hertz, extremely low frequency, very low frequency, low frequency, medium frequency, high frequency, very high frequency, ultra-high frequency, super-high frequency, extremely high frequency, terahertz broadcasts, etc.); Ethernet; X.25; powerline-type networking, e.g., Powerline audio video Ethernet, etc.; femtocell technology; Wi-Fi; worldwide interoperability for microwave access; enhanced general packet radio service; second generation partnership project (2G or 2GPP); third generation partnership project (3G or 3GPP); fourth generation partnership project (4G or 4GPP); long term evolution (LTE); fifth generation partnership project (5G or 5GPP); third generation partnership project universal mobile telecommunications system; third generation partnership project 2; ultra mobile broadband; high speed packet access; high speed downlink packet access; high speed uplink packet access; enhanced data rates for global system for mobile communication evolution radio access network; universal mobile telecommunications system terrestrial radio access network; or long term evolution advanced. As an example, a millimeter wave broadcast technology can employ electromagnetic waves in the frequency spectrum from about 30 GHz to about 300 GHz. These millimeter waves can be generally situated between microwaves (from about 1 GHz to about 30 GHz) and infrared (IR) waves, and are sometimes referred to extremely high frequency (EHF). The wavelength (k) for millimeter waves is typically in the 1-mm to 10-mm range.

The term “infer” or “inference” can generally refer to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference, for example, can be employed to identify a specific context or action, or can generate a probability distribution over states of interest based on a consideration of data and events. Inference can also refer to techniques employed for composing higher-level events from a set of events and/or data. Such inference results in the construction of new events or actions from a set of observed events and/or stored event data, whether the events, in some instances, can be correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

As used herein, the terms “connected,” “coupled,” or any variant thereof, means any connection or coupling, either direct or indirect, between two or more elements; the coupling of connection between the elements can be physical, logical, or a combination thereof. Where context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are, at times, shown as being performed in a series, these processes or blocks may instead be performed in parallel, or may be performed at different times. Further, any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

What has been described above includes examples of systems and methods illustrative of the disclosed subject matter. It is, of course, not possible to describe every combination of components or methods herein. One of ordinary skill in the art may recognize that many further combinations and permutations of the claimed subject matter are possible. Illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize. Furthermore, embodiments can be combined, elements of embodiments can be excluded, etc. In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
obtaining, by a device comprising at least one wireless power receiver, information indicating at least one motion applicable to the device to increase an amount of wireless power that the at least one wireless power receiver is receiving from at least one power transmitter; and
rendering, by the device via an interface, the information enabling the device to be moved according to the at least one motion to thereby increase the amount of wireless power that is being received by the device.

2. The method of claim 1, wherein the obtaining the information indicating the at least one motion applicable to the device comprises obtaining orientation change information indicating a change in at least one of a yaw of the device, a pitch of the device, or a roll of the device.

3. The method of claim 1, wherein the rendering of the information comprises rendering temporal information via the interface about at least one of an estimated amount of time for the device to reach a fully charged state based on a rate of power transfer associated the amount of wireless power that the at least one wireless power receiver is receiving from the at least one power transmitter, an estimated time at which the device will reach the fully charged state based on the rate of power transfer, or an estimated reduction in estimated time for the device to reach the fully charged state responsive to the device being moved according to the at least one motion.

4. The method of claim 1, wherein the rendering of the information comprises rendering directional information via the interface about a direction toward which the device is to be moved or reoriented to increase the amount of wireless power that is being received.

5. The method of claim 4, wherein the rendering of the directional information comprises rendering distance information representative of a distance along the direction that the device is to be moved from a current location to increase the amount of wireless power that is being received.

6. The method of claim 4, wherein the rendering of the directional information comprises rendering at least one of an arrow, text, or the text rendered as speech, indicating the direction toward which the device is to be moved or reoriented to increase the amount of wireless power that is being received.

7. The method of claim 4, wherein the rendering of the directional information comprises rendering vibratory feedback indicating the direction toward which the device is to be moved or reoriented to increase the amount of wireless power that is being received.

8. The method of claim 4, wherein the rendering of the directional information comprises:
when a first user motion taken with respect to the device is determined to result in a decrease in the amount of wireless power that is being received, controlling at least one of an intensity, a point of origin, or a force associated with oscillations applied to the device to oppose the first user motion, and
when a second user motion taken with respect to the device is determined to result in an increase in the amount of wireless power that is being received, controlling the at least one of the intensity, the point of origin, or the force associated with the oscillations applied to the device to aid the second user motion.

9. The method of claim 1, wherein the rendering of the information comprises rendering rate information about a change in position of the device to increase a rate of power transfer to the at least one wireless power receiver.

10. The method of claim 1, wherein the rendering of the information comprises rendering rate information about a change in orientation of the device to increase a rate of power transfer to the at least one wireless power receiver.

11. The method of claim 1, wherein the rendering of the information comprises initiating haptic feedback associated with the information, and further comprising:
varying, by the device, the haptic feedback resulting in updated haptic feedback, wherein
in response to the amount of power being received by the device increasing as a result of moving the device, the updated haptic feedback is updated according to a first function, and
in response to the amount of power being received by the device decreasing as a result of the moving the device, the updated haptic feedback is updated according to a second function different than the first function.

12. The method of claim 11, wherein the varying of the haptic feedback comprises varying at least one of a strength of the haptic feedback at a specified position on the device, or at a position on the device where the haptic feedback is to be felt.

13. The method of claim 1, further comprising:
at least one of enabling, by the device, the rendering of the information by the device where the rendering is disabled, or disabling, by the device, the rendering of the information by the device where the rendering is enabled.

14. The method of claim 13, wherein the enabling the rendering of the information comprises enabling the rendering in response to at least one of receiving an input via the interface of the device, determining that the device is within a defined range of the at least one power transmitter, or determining that a current amount of charge of the device has decreased below a threshold amount of charge defined for the device.

15. The method of claim 13, wherein the disabling the rendering of the information comprises disabling the rendering in response to at least one of receiving an input via the interface of the device, determining that the device is outside of a defined range of the at least power transmitter, determining that a current amount of charge of the device has increased above a threshold amount of charge defined for the device, or determining that the device is in a state of inactivity by a user of the device.

16. The method of claim 1, wherein the obtaining the information comprises obtaining the information from the at least one power transmitter.

17. The method of claim 1, wherein the obtaining the information comprises determining the information by the device.

18. The method of claim 1, wherein the device is a first device, and wherein the obtaining the information comprises obtaining the information from a second device wirelessly connected to the at least one power transmitter and connected to the first device.

19. The method of claim 1, wherein the information is first information, and further comprising:
transmitting, by the device to the at least one power transmitter, a signal comprising second information regarding the amount of wireless power that the at least one wireless power receiver is receiving from the at least one power transmitter.

20. The method of claim 1, wherein the rendering of the information comprises initiating audio feedback associated with the information, and further comprising:
varying, by the device, the audio feedback resulting in updated audio feedback, wherein the updated audio feedback is updated as a function of the amount of power being received by the device as the information changes as a result of moving the device according to the at least one motion.

21. The method of claim 20, wherein the varying the audio feedback comprises varying at least one of a strength of the audio feedback, a frequency of the audio feedback, or a frequency of occurrence of the audio feedback.

22. The method of claim 1, wherein the rendering of the information comprises rendering information regarding the presence of an interference-causing obstacle between the device and the at least one power transmitter, enabling the device to thereby increase the amount of wireless power that is being received by at least one of moving the interference-causing obstacle or moving the device to reduce an effect of interference by the interference-causing obstacle on transmissions by the at least one power transmitter as a result of increasing a degree to which the interference-causing obstacle is avoided by the transmissions.

23. The method of claim 1, wherein the rendering of the information comprises rendering information regarding the presence of living tissue between the device and the at least one power transmitter, enabling the device to thereby increase the amount of wireless power that is being received by at least one of moving the device or moving the living tissue to facilitate a decrease in transmissions by the at least one power transmitter that are re-directed or not transmitted in order to avoid the transmissions passing through the living tissue.

24. The method of claim 1, wherein the information is first information, wherein the device is in motion, and further comprising:
transmitting, by the device to at least one other device, a signal comprising second information indicating that a location of the device has changed from where the device was located when the device obtained the first information;
in response to the transmitting, receiving, by the device, new location information representative of a new location of the device to where to move the device to increase the amount of wireless power that is being received by the device; and
rendering, by the device, the new location information representative of the new location of the device.

25. The method of claim 1, wherein the device is in motion, wherein the information comprises trajectory information about a trajectory of the device in motion based on a current location of the device and prior locations of the device previous to the current location, and the method further comprising:
determining, by the device relative to the trajectory of motion of the device, new location information representative of a new location of the device to which to move the device along the trajectory of motion of the device to increase the amount of wireless power that the at least one wireless power receiver is receiving; and
rendering, by the device, the new location information representative of the new location of the device.

26. A machine-readable storage medium, comprising executable instructions that, when executed by a processor of a device comprising a wireless power receiver, facilitate performance of operations, comprising:
obtaining information indicating at least one action associated with the device to increase an efficiency of wireless power transfer with regard to wireless power transmissions that the wireless power receiver receives from the at least one wireless power transmitter; and
rendering, via a user interface of the device, the information indicating the at least one action, wherein, responsive to movement of the device according to the at least one action, the efficiency of the wireless power transfer is increased.

27. The machine-readable storage medium of claim 26, wherein the information is first information, and wherein the obtaining the first information comprises obtaining the first information in response to transmitting, to the at least one wireless power transmitter, a signal comprising second information regarding the efficiency of wireless power transfer.

28. The machine-readable storage medium of claim 27, wherein the signal is a first signal, and wherein the operations further comprise:
transmitting a second signal comprising location information regarding a current location of the device to the at least one wireless power transmitter.

29. A device, comprising:
a processor; and
a memory that stores executable instructions that, when executed by the processor, facilitate performance of operations, comprising:
based on action information indicating at least one action associated with the device that has been determined to be threshold likely to increase an amount of wireless power transfer from at least one wireless power transmitter to at least one wireless receiver device, rendering, via a user interface, the action information indicating the at least one action; and
in response to determining that the at least one wireless receiver device has been moved according to the at least one action responsive to movement of the device according to the at least one action, validating that the amount of the wireless power transfer has been increased.

30. The device of claim 29, wherein the validating that the amount of the wireless power transfer has been increased comprises determining that a number of interruptions in the wireless power transfer over a defined period of time has satisfied a criterion.

31. The device of claim 30, wherein the determining that the number of interruptions in the wireless power transfer over the defined period of time has satisfied the criterion comprises determining that a rate of interruptions in the wireless power transfer over the defined period of time is less than a threshold rate of interruptions.

32. The device of claim 30, wherein the determining that the number of interruptions in the wireless power transfer over the defined period of time has satisfied the criterion comprises determining that a percentage of power measurements associated with the number of interruptions for the defined period of time relative to overall power measurements for the defined period of time is less than a threshold percentage.
